(19) United States
(12) Patent Application Publication
(10) Pub. No.: US 2021/0400621 A1
(43) Pub. Date: Dec. 23, 2021

(54) Wireless Device, Radio Network Node and Methods Performed Therein for Handling Positioning in a Wireless Communication Network

(71) Applicant: Telefonaktiebolaget LM Ericsson (publ), Stockholm (SE)

(72) Inventors: Ritesh Shreevastav, Upplands Väsby (SE); Åke Busin, Sollentuna (SE); Fredrik Gunnarsson, Linköping (SE); Iana Siomina, Täby (SE)

(21) Appl. No.: 17/297,066

(22) PCT Filed: Nov. 15, 2019
(86) PCT No.: PCT/SE2019/051167

§ 371 Date: May 26, 2021

Related U.S. Application Data
(60) Provisional application No. 62/771,203, filed on Nov. 26, 2018.

(51) Int. Cl. H04W 64/00; H04W 24/10

(52) U.S. Cl. CPC H04W 64/003; H04W 24/10

(57) ABSTRACT

A method performed by a wireless device (110). The method is for handling positioning of the wireless device (110) in a wireless communication network (100). The wireless device (110) provides (604), to a radio network node (120) comprised in the wireless communication network (100), at least one of i) information, and ii) a location procedure configuration. The information is about a first location information request obtained from the radio network node (120) in a Radio Resource Control Reconfiguration message. The location procedure configuration is one of: a flag indication and b) a Packet Data Convergence Protocol, PDCP, Control protocol data unit, PDU. The flag indication conveys to the radio network node (120) that the wireless device (110) has an ongoing positioning session. The flag indication is in an RRC message. The PDCP Control PDU conveys to the radio network node that the wireless device has an ongoing positioning session.

### TECHNICAL FIELD

Embodiments herein relate to a wireless device, a radio network node and methods performed therein regarding wireless communication. In particular, embodiments herein relate to handling positioning of the wireless device in a wireless communication network.

### BACKGROUND

In a typical wireless communication network, wireless devices, also known as wireless communication devices, mobile stations, stations (STA) and/or user equipments (UE), may communicate via a Radio Access Network (RAN) to one or more core networks (CN). The RAN covers a geographical area which is divided into service areas, also known as cells, with each cell area being served by a radio network node e.g., a Wi-Fi access point or a radio base station (RBS), which in some networks may also be called, for example, a NodeB, an eNodeB or a gNodeB. The cell is a geographical area where radio coverage is provided by the radio network node. The radio network node operates on radio frequencies to communicate over an air interface with the wireless devices within range of the radio network node. The radio network node communicates over a downlink (DL) to the wireless device and the wireless device communicates over an uplink (UL) to the radio network node.

A Universal Mobile Telecommunications network (UMTS) is a Third Generation of Mobile Telecommunications Technology (3G) telecommunications network, which evolved from the second generation (2G) Global System for Mobile Communications (GSM). The UMTS terrestrial radio access network (UTRAN) is essentially a RAN using wideband code division multiple access (WCDMA) and/or High Speed Packet Access (HSPA) for user equipments. In a forum known as the Third Generation Partnership Project (3GPP), telecommunications suppliers propose and agree upon standards for e.g., third generation networks, and investigate enhanced data rate and radio capacity and upcoming generation networks. In some RANs, e.g., as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. This type of connection is sometimes referred to as a backhaul connection. The RNCs and BSCs are typically connected to one or more core networks.

Specifications for the Evolved Packet System (EPS), also called a Fourth Generation (4G) network, have been completed within the 3GPP and this work continues in the coming 3GPP releases, for example to specify a Fifth Generation (5G) network. The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio network nodes are directly connected to the EPC core network rather than to RNCs. In general, in E-UTRAN/LTE the functions of an RNC are distributed between the radio network nodes, e.g., eNodeBs in LTE, and the core network. As such, the RAN of an EPS has an essentially “flat” architecture comprising radio network nodes connected directly to one or more core networks, i.e., they are not connected to RNCs. To compensate for that, the E-UTRAN specification defines a direct interface between the radio network nodes, this interface being denoted the X2 interface.

With the emerging 5G technologies such as New Radio (NR), the use of very many transmit- and receive-antenna elements is of great interest as it makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals from a selected direction or directions, while suppressing unwanted signals from other directions.

Positioning has been a topic in LTE standardization since 3GPP Release (Rel) 9. The primary objective is to fulfill regulatory requirements for emergency call positioning. Positioning in NR is proposed to be supported by the architecture shown in FIG. 1. FIG. 1 is also showing the NG-RAN Rel-15 Location Services (LCS) Protocols. As depicted in FIG. 1, the relevant nodes for this architecture may be those comprised in a Next-Generation Radio Access Network (NG-RAN) 1, such as a gNB 2 and a Next-Generation eNB (ng-eNB) 3. The NG-eNB 3 in the example depicted in FIG. 1 comprises two Transmission Points (TP) 4. The Location management function (LMF) node 5 may be understood as the location node in NR. There may be also interactions between the location node 5 and the gNodeB 2 via the new radio positioning protocol annex (NRPPa) protocol. The interactions between the gNodeB 2 and a device 6, indicated as “UE” in FIG. 1, may be supported via the Radio Resource Control (RRC) protocol. In FIG. 1, the device 6 is a SET→SUPL Enabled Terminal. The gNB 2 may communicate with the device 6 via an NR-Uu interface 7. The ng-eNB 3 may communicate with the device 6 via an LTE-Uu interface 8. It may be noted that the gNB 2 and ng-eNB 3 may not always both be present in the NG-RAN 1. It may also be noted that when both the gNB 2 and NG-eNB 3 are present, the NG control plane interface (NG-C) 9, which may be defined between the NG-RAN 1 node and an Access and Mobility Management Function (AMF) 10, may be only present for one of them. The AMF 9 may have a connection via an NLs interface 11 with the LMF 5, which in turn may have a connection with an Evolved Serving Mobile Location Center (E-SM LC) 12.

In the legacy LTE standards, the following techniques may be supported. A first technique is Enhanced Cell ID. This technique may comprise essentially cell IDentifier (ID) information to associate a device to the serving area of a serving cell, and then additional information to determine a finer granularity position. A second technique is Assisted Global Navigation Satellite System (GNSS). GNSS information may be retrieved by the device, supported by assistance information provided to the device from the E-SM LC. A third technique is Observed Time Difference of Arrival (OTDOA). In this technique, the device may estimate the time difference of reference signals from different base stations and may then send this information to an E-SMLC for multilateration. A fourth technique is Uplink time difference of arrival (UTDOA). In this technique, the device may be requested to transmit a specific waveform that may be detected by multiple location measurement units, e.g., an eNB, at known positions. These measurements may then be forwarded to an E-SMLC for multilateration. A fifth technique may comprise sensor methods, such as a Biometric pressure sensor, which may provide vertical position of a device, and an Inertial Motion Unit (IMU) which may provide displacement.

The System Aspects Working Group 2 (SA2) is studying to enhance the above Positioning architecture and is looking into ways where a RAN may be location aware. In TR 23.731, SA2 lists several solutions for enhancing the location architecture. On a high level, the concept is to introduce Location Management Component in NG-RAN and/or NG-RAN to be an LCS client. FIG. 2 is a schematic diagram depicting an enhanced LCS architecture as proposed by SA2. As depicted in the figure, the SA2 enhanced LCS architecture in FIG. 2 proposes that the location management function (LMF) 12 architecture is split by including Location Management (LM) capabilities in the NG-RAN 13 and the wireless device 14, depicted as “UE”. The schematic diagram in FIG. 2 depicts an enhanced LCS architecture as proposed by SA2 with local LMF. The RAN-Location Management Component (LMC) 15 and wireless device-LMC 16 may perform a partial location management role in the RAN and wireless device, respectively, and implement a subset of the functionalities of the LMF 12 in the 5G Core Network (5GC) 17, as well as new functionalities arising out of performing location management at the RAN/UE levels.

The RAN-LMC 15 and wireless device-LMC 16 may perform the following roles in the enhanced LCS architecture. A first role may be location measurement collection. That is, performing and collecting, e.g., saving in internal or external memory, location-related measurements a.k.a., positioning measurements, on the Uu interface, the measurements may be DL or UL; also the collection may be of own measurements, but also for other LMCs. They may be considered local collectors with more extended memory capability. A second role may be position calculation. That is, compute absolute/relative positions based on collected location measurements. A third role may be location information report. That is, report calculated positions to requesting entities over the Uu interface, reporting collected measurements. A fourth role may be cooperation among peers. That is, share location measurements, position-related information, load balancing, etc. among peer LMCs, share positioning assistance data relevant for different LMCs in the same area, providing assistance data to a peer LMC for enhancing performing the measurements, sharing of positioning capability, e.g., types of measurements that may be performed and managed, types of signals which may be measured such as Synchronization signal block (SSB) or channel state information (CSI), downlink or uplink measurements or both, RATs in which the positioning measurements may be performed, positioning methods that may used for position calculation such as OTDOA or E-CID or UTDOA or any hybrid positioning, etc. LMC functionality-specific capability sharing, e.g., capability of performing the measurements on Uu but not position calculation, capability of collecting measurements for neighbour LMCs, etc. A fifth may be positioning performance monitoring. That is, monitor and predict positioning performance and location-related measurements performance. A sixth role may be communication to the CN. That is, to communicate with the LMF node 12, Access and Mobility Management Function (AMF) node 18 and other 5GC LCS functions. Other components to the architecture also depicted in FIG. 2 are, a Unified Data Management (UDM) 19, a Gateway Mobile Location Centre (GMLC) 20, a Location Retrieval Function (LRF) 21, as well as the interfaces between the different components N1 22, N2 23, NLg 24, NLs 25 and NLh 26.

Further, SA2 would like the NG-RAN 13 to be an LCS client which enables RAN to initiate procedure to fetch a wireless device 14 location from the LMF 12 via the AMF 18. In agreement with this, an external client 27 is also depicted on FIG. 2, having an Le interface 28 with each of the GMLC 20 and the LRF 21.

The next two figures depict two sequence flows for LCS and LMC, respectively, which are most likely going to be supported in 3GPP. In a first flow depicted in FIG. 3, the NG-RAN may be able to fetch the wireless device location from the AMF. In a second flow depicted in FIG. 4, the NG-RAN may be able to get a determined wireless device location based upon a wireless device measurements report for a wireless device assisted procedure, or obtain the user location from the wireless device for a wireless device based procedure.

The flow in FIG. 3 indicates a procedure corresponding to the first flow, where the NG-RAN 30 may request a Location service. This procedure may be used by the NG-RAN 30, when the target wireless device 32 is in Connection Management (CM)-CONNECTED state, as depicted in step 1, to request, at step 2, the AMF 31 to report the current location of the wireless device 32, depicted as “UE”. This is defined as solution #11 in SA2 TR23.731. At 3, the AMF 31 processes the authorization. At 4, the 5GC performs the Network Initiated Location Request (NI-LR) procedure, with involvement of the LMF 33, and at 5, the AMF 31 provides the RAN Location Response to the NG-RAN 30. The GMLC 34 is not involved in this procedure.

FIG. 4 depicts a procedure corresponding to the second flow, for a Location service exposure to NG-RAN. FIG. 4 shows the procedure that may be used by a serving AMF 40 to obtain a location estimate for the target wireless device 41 from the NG-RAN 42 with higher location accuracy than that possible using cell ID based location. At 1, the AMF 40 requests a location estimate for the target wireless device 41 from the NG-RAN 42 by initiating a location reporting control procedure, with a certain Location Quality of Service (QoS). At 2, the NG-RAN 42 sends a location measurement request to the wireless device 41, depicted as “UE”. At 3, the wireless device 41 sends a location measurement response to the NG-RAN 42, which then determines the UE location at step 4. At 5, the NG-RAN 42 sends a location report back to the AMF 40. At 6, there may be a UE trigger event that prompts the NG-RAN 42 to send another location measurement request to the wireless device 41, which sends a new location measurement response to the NG-RAN 42 at 8, which in turn determines again the UE location at step 9. At 10, the NG-RAN 42 sends a new location report back to the AMF 40. At 11, the AMF 40 instructs the NG-RAN 42 to cancel the location reporting.

The above proposed solutions have some drawbacks and need some additional work in RAN to enable to utilize the full benefits of having RAN being location aware. For instance, the solution in the first flow, depicted in FIG. 3, will incur delay and may not be apt for 5G time critical services. Similarly, the second flow, depicted in FIG. 4, needs to be simplified and integrated to normal RRC procedure.

### SUMMARY

An object herein is to provide a mechanism to in an efficient manner enable positioning of a wireless device in a wireless communication network.

According to a first aspect, the object is achieved, according to embodiments herein, by providing a method performed by a wireless device for handling positioning of the wireless device in a wireless communication network. The wireless device provides, to a radio network node comprised in the wireless communication network, at least one of: i) information and ii) a location procedure configuration. The information is about a first location information request obtained from the radio network node in a Radio Resource Control (RRC) Reconfiguration message. The location procedure configuration is one of: a) a flag indication and b) a Packet Data Convergence Protocol (PDCP) Control protocol data unit (PDU). The flag indication conveys to the radio network node that the wireless device has an ongoing positioning session. The flag indication is in an RRC message. The PDCP Control PDU conveys to the radio network node that the wireless device has an ongoing positioning session.

According to a second aspect the object is achieved, according to embodiments herein, by providing a method performed by a radio network node for handling positioning of a wireless device in a wireless communication network. The radio network node obtains, from a wireless device comprised in the wireless communication network, at least one of: i) the information and ii) the location procedure configuration. The information is about a first location information request sent by the radio network node to the wireless device in an RRC Reconfiguration message. The location procedure configuration is one of: a) the flag indication and b) the PDCP Control PDU. The flag indication conveys to the radio network node, that the wireless device has the ongoing positioning session. The flag indication is in the RRC message. The PDCP Control PDU conveys to the radio network node that the wireless device has an ongoing positioning session.

According to embodiments herein the object may be achieved by providing a radio network node and a wireless device configured to perform the methods herein.

According to a third aspect, the object is achieved, according to embodiments herein, by providing a wireless device, for handling the positioning of the wireless device in the wireless communication network. The wireless device is configured to provide, to the radio network node comprised in the wireless communication network, at least one of: i) the information and ii) the location procedure configuration. The information is about the first location information request configured to be obtained from the radio network node in the Reconfiguration message. The location procedure configuration is configured to be one of: a) the flag indication and b) the PDCP Control PDU. The flag indication is configured to convey to the radio network node that the wireless device has the ongoing positioning session. The flag indication is configured to be in the RRC message. The PDCP Control PDU is configured to convey to the radio network node that the wireless device has an ongoing positioning session.

According to a fourth aspect the object is achieved, according to embodiments herein, by providing a radio network node, for handling the positioning of the wireless device in the wireless communication network. The radio network node is configured to obtain, from the wireless device configured to be comprised in the wireless communication network, at least one of: i) the information and ii) the location procedure configuration. The information is about the first location information request configured to be sent by the radio network node to the wireless device in the RRC Reconfiguration message. The location procedure configuration, is configured to be one of: a) the flag indication and b) the PDCP Control PDU. The flag indication is configured to convey to the radio network node, that the wireless device has the ongoing positioning session. The flag indication is configured to be in the RRC message. The PDCP Control PDU is configured to convey to the radio network node that the wireless device has an ongoing positioning session.

Embodiments herein provide methods and embodiments to simplify a network architecture to be used by the radio network node for retrieving and determining the location of the wireless device. Thus, embodiments herein provide a signalling efficient solution for determining a position of the wireless device.

By the wireless device providing the information about the first location information request to the radio network node, the wireless device enables the radio network node to function as an LMC, and determine the location of the wireless device relying on location measurements that the wireless device may provide to it. This enables the radio network node to act as LMC with a simplified architecture with respect to existing procedures since this may enable the radio network node to refrain from relying on an LTE positioning protocol (LPP) procedure, which may be understood to involve a more complex architecture, duplicating protocols and procedures and further transporting messages based upon container, and longer delays in processing.

By the wireless device providing the location procedure configuration, that is, the flag or the PDCP Control PDU, to the radio network node, the wireless device enables the radio network node to make a decision on whether to invoke LCS functionality or not, and obtain the location of the wireless device relying on the already ongoing LPP session the wireless device may have. This may be understood to considerably shorten the latency of the location procedure, since the radio network node may be enabled to know that it may request the location information from the core network, refraining from initiating a new LPP session from the beginning itself. The location information that may then be obtained by the radio network node may be up to date, as the LPP session is ongoing, and obtained within a shorter time period, and with reduced signalling.

### BRIEF DESCRIPTION OF THE DRAWINGS

Embodiments will now be described in more detail in relation to the enclosed drawings, in which:

FIG. 1 is a schematic diagram depicting an overview of an architecture for positioning in NR;

FIG. 2 is a schematic diagram depicting an overview of an architecture for positioning in NR;

FIG. 3 is a schematic diagram depicting an overview of some signalling processes for positioning in NR;

FIG. 4 is a schematic diagram depicting an overview of some signalling processes for positioning in NR;

FIG. 5 is a schematic overview depicting a wireless communication network according to embodiments herein;

FIG. 6 is a schematic diagram depicting a method performed by a wireless device according to embodiments herein;

FIG. 7 is a schematic diagram depicting a method performed by a radio network node according to embodiments herein;

FIG. 8A-8B show an example of methods performed by a wireless device according to embodiments herein;

FIG. 9A-9C show an example of methods performed by a radio network node or a network node according to embodiments herein;

FIG. 10 shows methods performed by a wireless device according to an example of embodiments herein;

FIG. 11 shows methods performed by a wireless device according to an example of embodiments herein;

FIG. 12 shows methods performed by a radio network node or a network node according to an example of embodiments herein;

FIG. 13 shows methods performed by a radio network node or a network node according to an example of embodiments herein;

FIG. 14 shows a combined flowchart and signalling scheme according to an example of embodiments herein;

FIG. 15 shows a combined flowchart and signalling scheme according to an example of embodiments herein;

FIG. 16 shows a combined flowchart and signalling scheme according to an example of embodiments herein;

FIG. 17 an octet is shown according to an example of embodiments herein;

FIG. 18A-18B show a block diagram depicting two examples, in panels a) and b), respectively, of a radio network node according to embodiments herein;

FIG. 19A-19B show a block diagram depicting two examples of a wireless device according to embodiments herein;

FIG. 20 shows a telecommunication network connected via an intermediate network to a host computer in accordance with some embodiments;

FIG. 21 shows a host computer communicating via a base station with a user equipment over a partially wireless connection in accordance with some embodiments;

FIG. 22 shows methods implemented in a communication system including a host computer, a base station and a user equipment in accordance with some embodiments;

FIG. 23 shows methods implemented in a communication system including a host computer, a base station and a user equipment in accordance with some embodiments;

FIG. 24 shows methods implemented in a communication system including a host computer, a base station and a user equipment in accordance with some embodiments; and

FIG. 25 shows methods implemented in a communication system including a host computer, a base station and a user equipment in accordance with some embodiments.

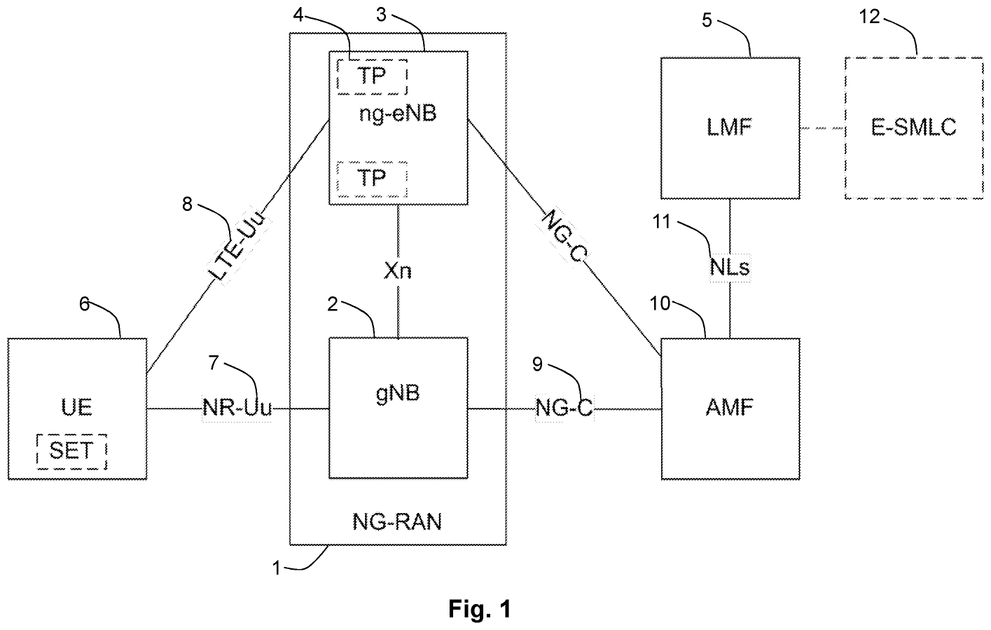

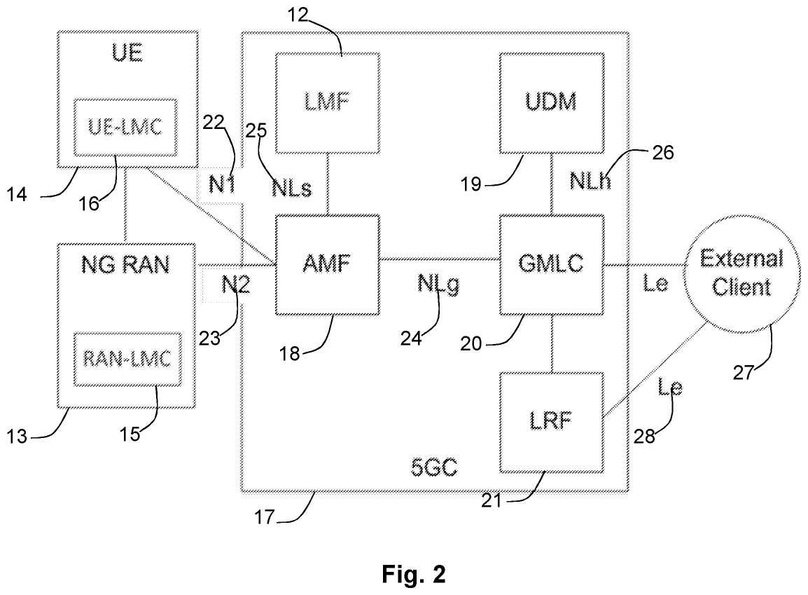

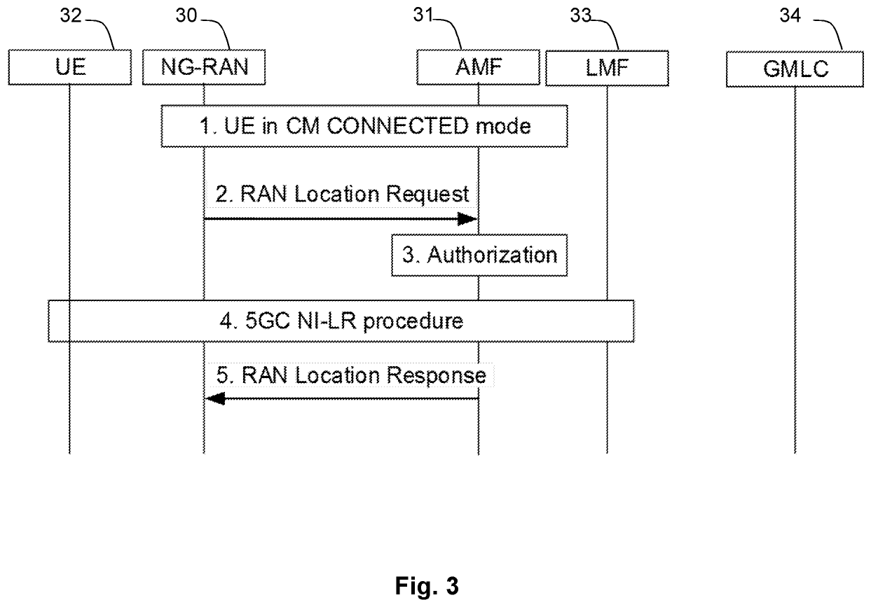

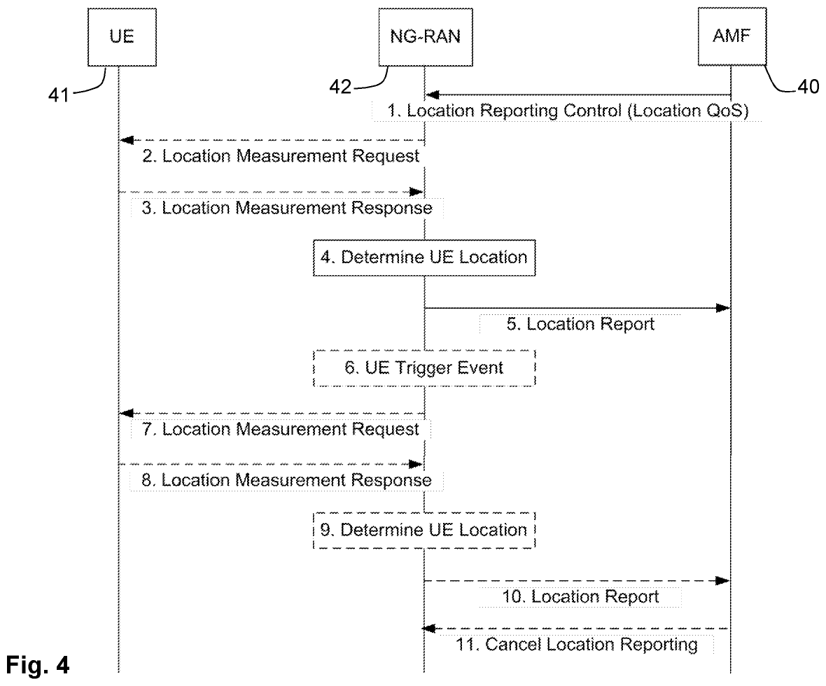

### DETAILED DESCRIPTION

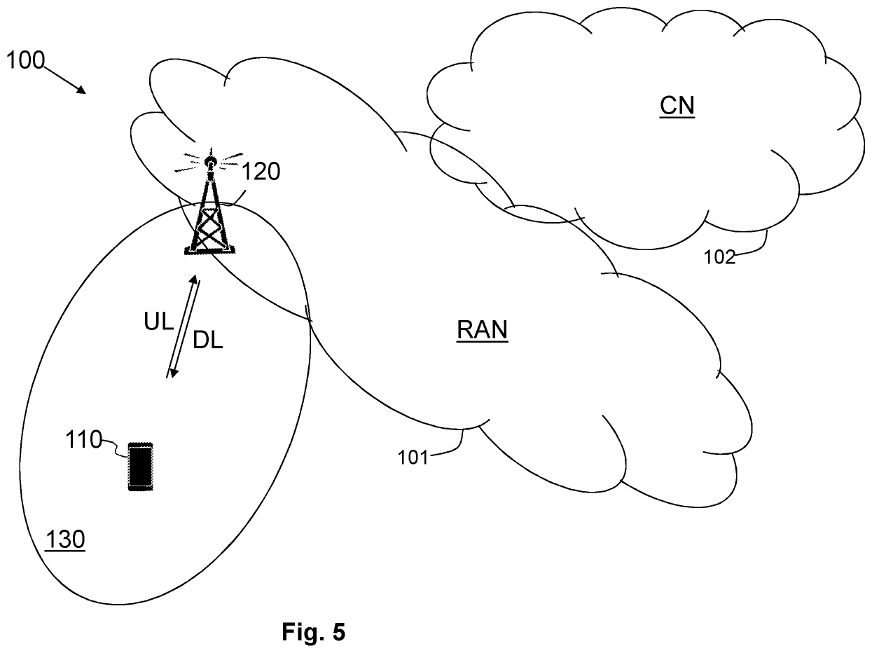

Embodiments herein relate to wireless communication networks in general. FIG. 5 is a schematic overview depicting a wireless communication network 100. The wireless communication network 100 comprises one or more RANs 101 and one or more CNs 102. The wireless communication network 100 may use one or a number of different technologies. Embodiments herein relate to recent technology trends that are of particular interest in a 5G context, however, embodiments are also applicable in further development of existing wireless communication systems such as e.g., LTE and Wideband Code Division Multiple Access (WCDMA).

In the wireless communication network 100, wireless devices configured to communicate with one another over a sidelink e.g., a wireless device 110, such as a terminal e.g. a mobile station, a non-access point (non-AP) STA, a STA, a user equipment and/or a wireless terminal, may be configured for communication from a Network (NW). It should be understood by the skilled in the art that “wireless device” is a non-limiting term which means any terminal, wireless communication terminal, user equipment, NB-IoT device, Machine Type Communication (MTC) device, Device to Device Communication (D2D) terminal, or node e.g. smart phone, laptop, mobile phone, sensor, relay, mobile tablets or even a small base station capable of communicating using radio communication with a radio network node or a wireless device.

The wireless communication network 100 comprises a radio network node 120 providing radio coverage over a geographical area, a service area 130 or cell, of a first radio access technology (RAT), such as NR or similar. The radio network node 120 may be a transmission and reception point such as an access node, an access controller, a base station, e.g., a radio base station such as a gNodeB (gNB), an evolved Node B (eNB, eNode B), a base transceiver station, a radio remote unit, an Access Point Base Station, a base station router, a Wireless Local Area Network (WLAN) access point or an Access Point Station (AP STA), a transmission arrangement of a radio base station, a stand-alone access point or any other network unit or node capable of communicating with a wireless device within the area served by the radio network node 120 depending e.g., on the first radio access technology and terminology used. The radio network node 120 may in some embodiments be a network node such as a core network node connected to the RAN. The radio network node 120 may be referred to as a serving radio network node wherein the service area 130 may be referred to as a serving cell, and the serving network node communicates with the wireless device 110 in form of DL transmissions to the wireless device 110 and UL transmissions from the wireless device 110. It should be noted that a service area 130 may be denoted as cell, beam, beam group or similar to define an area of radio coverage.

Methods and embodiments provide an efficient manner of signalling to be used by the radio network node 120 for retrieving and determining the location, or position, of the wireless device 110. Embodiments herein provide a solution well integrated with a RAN solution, that may minimize Latency and/or provide a simplified lean procedure. Embodiments herein provide a solution that may be understood to be easy to invoke and may enable avoiding duplication of protocols.

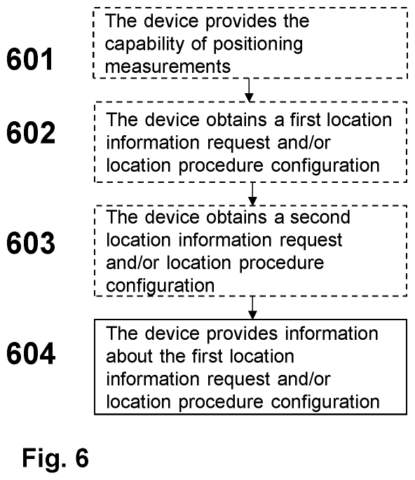

Embodiments of a method performed by the wireless device 110, will now be described with reference to the flowchart depicted in FIG. 6. The method is handling positioning of the wireless device 110 in the wireless communication network 100. In some embodiments, the wireless device 110 may be comprised in a New Generation Radio Access Network.

The method comprises the following actions. Several embodiments are comprised herein. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples. In FIG. 6, optional actions are represented in boxes with dashed lines.

Action 601

In some embodiments, the wireless device 110 may in this Action 601, provide, to a first network node, such as e.g., the radio network node 120, a capability indication. The capability indication may indicate a capability of the wireless device 110 of positioning measurements in a Radio Resource Control (RRC) procedure. In other words, the wireless device 110 may, in this Action 601, send a capability report providing information whether the wireless device is capable of performing measurements for positioning/location estimations. More details for wireless device capability is provided in an Abstract Syntax Notation One (ASN.1) example below.

In other examples, the first network node may be an LMF.

The providing in this Action 601 may be understood as e.g., sending, and may be performed e.g., via a an UL link.

The providing in this Action 601 may be performed, optionally, upon a request from a first network node, such as, for example, the radio network node 120.

In some embodiments, the capability indication may be comprised in a MeasAndMobParameters information element. The information element (IE) MeasAndMobParameters may be used to convey wireless device capabilities related to measurements for radio resource management (RRM), radio link monitoring (RLM) and mobility e.g., handover. An ASN.1 example of how the MeasAndMobParameters IE may be used according to embodiments herein to convey the capability indication is provided below, where the changes that may need to be made to this IE, in a test implementing example, are underlined.

MeasAndMobParameters information element

-- ASN1START
-- TAG-MEASANDMOBPARAMETERS-START

| | |
|---|---|
| MeasAndMobParameters ::= | SEQUENCE { |
| measAndMobParametersCommon | MeasAndMobParametersCommon |

OPTIONAL,

| | |
|---|---|
| measAndMobParametersXDD-Diff | MeasAndMobParametersXDD-Diff |
| OPTIONAL, | |
| measAndMobParametersFRX-Diff | MeasAndMobParametersFRX-Diff |

OPTIONAL
}

| MeasAndMobParametersCommon ::= | SEQUENCE { | |
|---|---|---|
| supportedGapPattern | BIT STRING (SIZE (22)) | OPTIONAL, |
| ssb-RLM | ENUMERATED {supported} | OPTIONAL, |
| ssb-AndCSI-RS-RLM | ENUMERATED {supported} | OPTIONAL, |

```
    ...,
    [[
```

| | | |
|---|---|---|
| eventB-MeasAndReport | ENUMERATED {supported} | OPTIONAL, |

| | | |
|---|---|---|
| handoverFDD-TDD | ENUMERATED {supported} | OPTIONAL, |
| eutra-CGI-Reporting | ENUMERATED {supported} | OPTIONAL, |

| | | |
|---|---|---|
| nr-CGI-Reporting | ENUMERATED {supported} | OPTIONAL |

```
    ]],
    [[
    positioningMeasCapability PositioningMeasCapability OPTIONAL
    ]]
}
```

| | |
|---|---|
| MeasAndMobParametersXDD-Diff ::= | SEQUENCE { |

| | | |
|---|---|---|
| intraAndInterF-MeasAndReport | ENUMERATED {supported} | OPTIONAL, |
| eventA-MeasAndReport | ENUMERATED {supported} | OPTIONAL, |

```
    ...,
    [[
```

| | | |
|---|---|---|
| handoverInterF | ENUMERATED {supported} | OPTIONAL, |

| | | |
|---|---|---|
| handoverLTE | ENUMERATED {supported} | OPTIONAL, |

| | | |
|---|---|---|
| handover-eLTE | ENUMERATED {supported} | OPTIONAL |

]]
}

| | |
|---|---|
| MeasAndMobParametersFRX-Diff ::= | SEQUENCE { |

| | | |
|---|---|---|
| ss-SINR-Meas | ENUMERATED {supported} | OPTIONAL, |
| csi-RSRP-AndRSRQ-MeasWithSSB | ENUMERATED {supported} | OPTIONAL, |
| csi-RSRP-AndRSRQ-MeasWithoutSSB | ENUMERATED {supported} | OPTIONAL, |
| csi-SINR-Meas | ENUMERATED {supported} | OPTIONAL, |
| csi-RS-RLM | ENUMERATED {supported} | OPTIONAL, |

```
    ...,
    [[
```

| | | |
|---|---|---|
| handoverInterF | ENUMERATED {supported} | OPTIONAL, |

| | | |
|---|---|---|
| handoverLTE | ENUMERATED {supported} | OPTIONAL, |

| | | |
|---|---|---|
| handover-eLTE | ENUMERATED {supported} | OPTIONAL |

```
    ]]
}
-- TAG-MEASANDMOBPARAMETERS-STOP
-- ASN1STOP
PositioningMeasCapability ::= SEQUENCE {
    angleOfArrival ENUMERATED { supported } OPTIONAL,
    angleOfDeparture ENUMERATED { supported } OPTIONAL,
    ueBasedPositioning ENUMERATED { supported } OPTIONAL,
    periodicalReporting ENUMERATED { supported } OPTIONAL,
    triggeredReporting ENUMERATED { supported } OPTIONAL,
    idleStateForMeasurements ENUMERATED { required } OPTIONAL
    ss-SINR-Meas ENUMERATED {supported} OPTIONAL,
    csi-RSRP-AndRSRQ-MeasWithSSB ENUMERATED {supported} OPTIONAL,
    csi-RSRP-AndRSRQ-MeasWithoutSSB ENUMERATED {supported} OPTIONAL,
    csi-SINR-Meas ENUMERATED {supported} OPTIONAL,
    ...,
}
```

By the wireless device 110 providing the capability indication to the radio network node 120 in this Action 601, the wireless device 110 enables the radio network node 120 to know it may act as an LMC, and determine the location of the wireless device 110 relying on location 50 measurements that now the radio network node 120 knows the wireless device 110 is able to providing. This is performed with a simplified architecture with respect to existing procedures since this may enable the radio network node 120 to refrain from relying on an LTE positioning protocol (LPP) procedure, which may be understood to involve a more complex architecture and longer delays in processing. There may be many measurements that the wireless device 110 may perform for RRM, such as RSRP and/or RSRQ, further based upon this RSRP values, the base station may also be able to obtain the angular information. Thus, the radio network node 120 may be understood to be enabled to determine the location of the wireless device 110 without performing additional or complex measurements from the wireless device 110.

Action 602

In this Action 602, the wireless device 110 may obtain, from the radio network node 120, a first location information request in an RRC Reconfiguration message. This may happen if, for any reason, positioning of the wireless device 110 is desired, for example, because positioning is triggered at the radio network node 120.

The obtaining of the first location information request in this Action 602 may be performed based on the sending of the capability indication in Action 601.

In this Action 602, a configuration message such as an radio resource control (RRC) Reconfiguration message may be obtained by the wireless device 110, which may include what sort of measurement from the wireless device 110 may be required.

An example of a measurement configuration may comprise one of more of the following:
Reference signal received power (RSRP) or reference signal receive quality (RSRQ) of a serving cell, and desired intra or inter-frequency or inter-RAT neighbor cells may be configured;
RSRP/RSRQ of the serving cell and desired intra or inter-frequency or inter-RAT neighbor beams may be configured;
Wireless device reception-transmission (Rx-Tx) of the serving cell and desired intra or inter-frequency or inter-RAT neighbor cells may be configured;
Configuration to report Best Beam Id or Beam Id above certain thresholds; and
Angle of arrival (AoA) and Angle of departure (AoD) of the corresponding configured beams.

Further Examples of positioning measurements may comprise one of more of the following:
Absolute or relative, e.g., with respect to the configured or pre-defined reference, time-based measurements, e.g., time of arrival, round trip time (RTT), time difference, or delay measurements;
Absolute or relative, e.g., with respect to the configured or pre-defined reference, power-based measurements, e.g., signal strength such as RSRP or signal to noise ratio (SNR) or signal quality such as RSRQ or signal to interference plus noise ratio (SINR) or energy Es/Iot, interference measurements such as received signal strength indicator (RSSI)
Absolute or relative, e.g., with respect to the configured or pre-defined reference, angular measurements, e.g., AoA; and
Code phase or carrier phase measurements.

The obtaining in this Action 602 may be understood as receiving and may be performed e.g., via a DL link.

In some embodiments, the first location information request may be comprised in a MeasConfig information element.

For example, the existing MeasConfig as part of an RRC Reconfiguration may be extended with an information element, or a new Positioning Specific MeasConfig may be introduced.

The IE MeasConfig may be understood to be specify measurements to be performed by the wireless device 110, and may cover intra-frequency, inter-frequency and inter-RAT mobility as well as configuration of measurement gaps.

An ASN.1 example of how the MeasConfig 1E may be used according to embodiments herein to convey the first location information request is provided below, where the changes that may need to be made to this IE, in a test implementing example, are underlined.

MeasConfig information element

-- ASN1START
-- TAG-MEAS-CONFIG-START

| | |
|---|---|
| MeasConfig ::= | SEQUENCE { |

| | |
|---|---|
| measObjectToRemoveList | MeasObjectToRemoveList |

OPTIONAL, -- Need N

| | |
|---|---|
| measObjectToAddModList | MeasObjectToAddModList |

OPTIONAL, -- Need N

| | |
|---|---|
| reportConfigToRemoveList | ReportConfigToRemoveList |

OPTIONAL, -- Need N

| | |
|---|---|
| reportConfigToAddModList | ReportConfigToAddModList |

OPTIONAL, -- Need N

| | |
|---|---|
| measIdToRemoveList | MeasIdToRemoveList |

OPTIONAL, -- Need N

| | |
|---|---|
| measIdToAddModList | MeasIdToAddModList |

OPTIONAL, -- Need N

| | |
|---|---|
| s-MeasureConfig | CHOICE { |

| | |
|---|---|
| ssb-RSRP | RSRP-Range, |
| csi-RSRP | RSRP-Range |

}
OPTIONAL, -- Need M

| | |
|---|---|
| quantityConfig | QuantityConfig |

OPTIONAL, -- Need M

| | |
|---|---|
| measGapConfig | MeasGapConfig |

OPTIONAL, -- Need M

| | |
|---|---|
| measGapSharingConfig | MeasGapSharingConfig |

```
OPTIONAL, -- Need M
    ...,
    positioningMeasConfig PositioningMeasConfig
    OPTIONAL, -- Need M
}
```

| | |
|---|---|
| MeasObjectToRemoveList ::= | SEQUENCE (SIZE (1..maxNrofObjectId)) OF |

MeasObjectId

| | |
|---|---|
| MeasIdToRemoveList ::= | SEQUENCE (SIZE (1..maxNrofMeasId)) OF MeasId |
| ReportConfigToRemoveList ::= | SEQUENCE (SIZE (1..maxReportConfigId)) OF |

```
ReportConfigId
-- TAG-MEAS-CONFIG-STOP
-- ASN1STOP
PositioningMeasConfig ::= SEQUENCE {
    posMeasObjectToRemoveList MeasObjectToRemoveList
OPTIONAL, -- Need N
    posMeasObjectToAddModList MeasObjectToAddModList
OPTIONAL, -- Need N
    posReportConfigToRemoveList ReportConfigToRemoveList
OPTIONAL, -- Need N
    reportConfigToAddModList ReportConfigToAddModList
OPTIONAL, -- Need N
    posMeasIdToRemoveList MeasIdToRemoveList
OPTIONAL, -- Need N
    measIdToAddModList MeasIdToAddModList
OPTIONAL, -- Need N
    s-MeasureConfig CHOICE {
        ssb-RSRP RSRP-Range,
        csi-RSRP RSRP-Range
    }
OPTIONAL, -- Need M
    quantityConfig QuantityConfig
OPTIONAL, -- Need M
    measGapConfig MeasGapConfig
OPTIONAL, -- Need M
    measGapSharingConfig MeasGapSharingConfig
OPTIONAL, -- Need M
    ...
}
MeasObjectToRemoveList ::= SEQUENCE (SIZE (1..maxNrofObjectId)) OF
MeasObjectId
MeasIdToRemoveList ::= SEQUENCE (SIZE (1..maxNrofMeasId)) OF MeasId
ReportConfigToRemoveList ::= SEQUENCE (SIZE (1..maxReportConfigId)) OF
ReportConfigId
-- TAG-POS-MEAS-CONFIG-STOP
-- ASN1STOP
```

Action 603

In some embodiments, the wireless device 110 may, in this Action 603, obtain a second location information request. In some embodiments, the wireless device 110 may obtain the second location information request from a New Generation Radio Access Network node, such as the radio network node 120. In some of such embodiments, the second location information request may be obtained by the wireless device 110, e.g., at a different point in time than Action 602, when for example, the wireless device 110 has an ongoing LPP session. In such embodiments, by the wireless device 110 obtaining the second location information request, the wireless device 110 may be enabled to inform the radio network node 120 that it has an ongoing LPP session, as will be explained in option ii of the next Action.

In other embodiments, the wireless device 110 may obtain the second location information request from another network node, such as e.g., the AMF.

The obtaining in this Action 603 may be understood as receiving and may be performed e.g., via a DL link.

Action 604

In this Action 604, the wireless device 110 provides, to the radio network node 120 comprised in the wireless communication network 100, at least one of the following in a respective RRC message: i) information about the first location information request obtained from the radio network node 120 in the RRC Reconfiguration message, and ii) a location procedure configuration. The location procedure configuration is one of: a) a flag indication and b) a Packet Data Convergence Protocol (PDCP) Control protocol data unit (PDU). The flag indication conveys to the radio network node 120 that the wireless device 110 has an ongoing positioning session. The flag indication is in an RRC message. The PDCP Control PDU conveys to the radio network node that the wireless device has an ongoing positioning session.

The RRC message in ii) may be understood to be a different RRC message than the RRC Reconfiguration message in i). Hence, in the context of this method and any reciprocal actions from the radio network node 120, any reference to “the RRC message” may be understood to refer to the RRC message in ii), wherein any reference to “the RRC Reconfiguration message” may be understood to refer to the RRC Reconfiguration message in i).

The providing in this Action 601 may be understood as e.g., sending, and may be performed e.g., via an UL link.

In a first group of embodiments, the wireless device 110 may provide the information about the first location information request. The first group of embodiments may correspond to embodiments wherein the NG-RAN, comprising the radio network node 120, may act as LMC.

In some of the first group embodiments wherein the wireless device 110 may provide the information about the first location information request, the method may further comprise performing Action 602.

In some of the first group embodiments wherein the wireless device 110 may provide the information about the first location information request, the method may further comprise performing Action 601, that is providing the capability indication.

The information about the first location may, in some embodiments, be a measurement report. The measurement report may be comprised in a MeasResults information element. The IE MeasResults may be understood to cover measured results for intra-frequency, inter-frequency, and inter-RAT mobility.

An ASN.1 example of how the MeasResults IE may be used according to embodiments herein to convey the information about the first location is provided below, where the changes that may need to be made to this IE, in a test implementing example, are underlined.

MeasResults information element

-- ASN1START
-- TAG-MEAS-RESULTS-START

| | |
|---|---|
| MeasResults ::= | SEQUENCE { |
| measId | MeasId, |
| measResultServingMOList | MeasResultServMOList, |
| measResultNeighCells | CHOICE { |
| measResultListNR | MeasResultListNR, |

...,

| | |
|---|---|
| measResultListEUTRA | MeasResultListEUTRA |

```
    }
OPTIONAL,
    ...,
    [[
      lppSessionActive ENUMERATED {true} OPTIONAL
    ]]
}
```

| | |
|---|---|
| MeasResultServMOList ::= | SEQUENCE (SIZE (1..maxNrofServingCells)) OF |

MeasResultServMO

| | |
|---|---|
| MeasResultServMO ::= | SEQUENCE { |
| servCellId | ServCellIndex, |
| measResultServingCell | MeasResultNR, |
| measResultBestNeighCell | MeasResultNR |

OPTIONAL,
...
}

| | |
|---|---|
| MeasResultListNR ::= | SEQUENCE (SIZE (1..maxCellReport)) OF |

MeasResultNR

| | |
|---|---|
| MeasResultNR ::= | SEQUENCE { |
| physCellId | PhysCellId |

OPTIONAL,

| | |
|---|---|
| measResult | SEQUENCE { |
| cellResults | SEQUENCE{ |
| resultsSSB-Cell | MeasQuantityResults |

OPTIONAL,

| | |
|---|---|
| resultsCSI-RS-Cell | MeasQuantityResults |

OPTIONAL
},

| | |
|---|---|
| rsIndexResults | SEQUENCE{ |
| resultsSSB-Indexes | ResultsPerSSB-IndexList |

OPTIONAL,

| | |
|---|---|
| resultsCSI-RS-Indexes | ResultsPerCSI-RS-IndexList |

```
OPTIONAL
        }
OPTIONAL
    },
    ...,
    [[
```

| | |
|---|---|
| cgi-Info | CGI-Info |

OPTIONAL
]]
}

| | |
|---|---|
| MeasResultListEUTRA ::= | SEQUENCE (SIZE (1..maxCellReport)) OF |

MeasResultEUTRA

| | |
|---|---|
| MeasResultEUTRA ::= | SEQUENCE { |
| physCellId | PhysCellId, |
| measResult | MeasQuantityResultsEUTRA, |
| cgi-Info | SEQUENCE { |
| cgi-info-EPC | SEQUENCE { |
| cgi-info-EPC-legacy | CellAccessRelatedInfo-EUTRA-EPC, |
| cgi-info-EPC-list | SEQUENCE (SIZE (1..maxPLMN)) OF |
| CellAccessRelatedInfo-EUTRA-EPC | OPTIONAL |

} OPTIONAL,

| | |
|---|---|
| cgi-info-5GC | SEQUENCE (SIZE (1..maxPLMN)) OF |
| CellAccessRelatedInfo-EUTRA-5GC | OPTIONAL, |
| freqBandIndicator | FreqBandIndicatorEUTRA, |
| multiBandInfoList | MultiBandInfoListEUTRA |

OPTIONAL,

| | |
|---|---|
| freqBandIndicatorPriority | ENUMERATED {true} |

```
OPTIONAL
    }
OPTIONAL,
    ...
}
```

| | |
|---|---|
| MultiBandInfoListEUTRA ::= | SEQUENCE (SIZE (1..maxMultiBands)) OF |

FreqBandIndicatorEUTRA

| | |
|---|---|
| MeasQuantityResults ::= | SEQUENCE { |
| rsrp | RSRP-Range |

OPTIONAL,

| | |
|---|---|
| rsrq | RSRQ-Range |

OPTIONAL,

| | |
|---|---|
| sinr | SINR-Range |

OPTIONAL
}

| | |
|---|---|
| MeasQuantityResultsEUTRA ::= | SEQUENCE { |
| rsrp | RSRP-RangeEUTRA |

OPTIONAL,

| | |
|---|---|
| rsrq | RSRQ-RangeEUTRA |

OPTIONAL,

| | |
|---|---|
| sinr | SINR-RangeEUTRA |

OPTIONAL
}

| | |
|---|---|
| ResultsPerSSB-IndexList::= | SEQUENCE (SIZE (1..maxNrofIndexesToReport2)) |

OF ResultsPerSSB-Index

| | |
|---|---|
| ResultsPerSSB-Index ::= | SEQUENCE { |
| ssb-Index | SSB-Index, |
| ssb-Results | MeasQuantityResults |

OPTIONAL
}

| | |
|---|---|
| ResultsPerCSI-RS-IndexList::= | SEQUENCE (SIZE (1..maxNrofIndexesToReport2)) |

OF ResultsPerCSI-RS-Index

| | |
|---|---|
| ResultsPerCSI-RS-Index ::= | SEQUENCE { |
| csi-RS-Index | CSI-RS-Index, |
| csi-RS-Results | MeasQuantityResults |

OPTIONAL
}
-- TAG-MEAS-RESULTS-STOP
-- ASN1STOP

In the first group of embodiments, by the wireless device 110 providing the information about the first location information request to the radio network node 120 in this Action 604, the wireless device 110 enables the radio network node 120 to act as an LMC, and determine the location of the wireless device 110 relying on location measurements that the wireless device 110 may provide to it in this Action 604, e.g., in a measurement report. This enables the radio network node 120 to act as LMC with a simplified architecture with respect to existing procedures since this may enable the radio network node 120 to refrain from relying on an LTE positioning protocol (LPP) procedure, which may be understood to involve a more complex architecture and longer delays in processing.

In a second group of embodiments, the wireless device 110 may provide the location procedure configuration, e.g., the flag. The second group of embodiments may correspond to embodiments wherein the NG-RAN, comprising the radio network node 120, may act as LCS.

In some of the second group of embodiments, the wireless device 110 may provide 604 the location procedure configuration in the PDCP Control PDU. In more particular embodiments, the location procedure configuration may be indicated via a PDU type field in the PDCP Control PDU. The PDU type field may indicate the type of control information that may be included in the corresponding PDCP Control PDU field. The field may have a length of 3 bits. An example of how the location procedure configuration may be indicated via the PDU type field according to embodiments herein is shown in Table 1 below.

TABLE 1

| Bit | Description |
|---|---|
| 000 | PDCP status report |
| 001 | Interspersed ROHC feedback |
| 010 | Location Session |
| 011-111 | Reserved |

In some of the first group embodiments wherein the wireless device 110 may provide the location procedure configuration in this Action 604, the method may further comprise performing Action 603.

In the second group of embodiments, by the wireless device 110 providing the location procedure configuration, that is, the flag or the PDCP Control PDU, to the radio network node 120 in this Action 604, the wireless device 110 enables the radio network node 120 to act as an LCS, and obtain the location of the wireless device 110 relying on the already ongoing LPP session the wireless device 130 may have. This may be understood to considerably shorten the latency of the location procedure, since the radio network node 120 may be enabled to know that it may request the location information from the core network, refraining from initiating a new LPP session from the beginning itself. The location information that may then be obtained by the radio network node 120 may be up to date, as the LPP session is ongoing, and obtained within a shorter time period, and with reduced signalling.

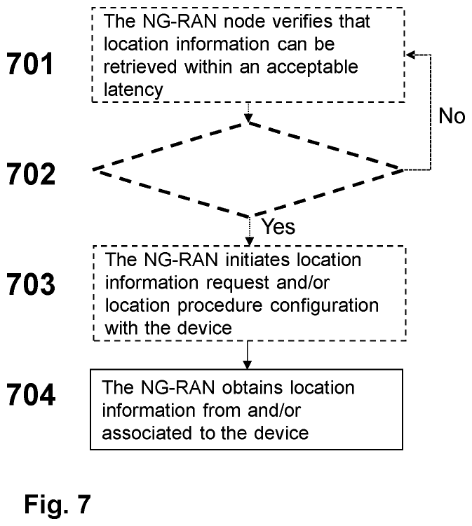

Embodiments of method, performed by the radio network node 120, will now be described with reference to the flowchart depicted in FIG. 7. The method may be understood to be for handling the positioning of the wireless device 110 in the wireless communication network 100. The radio network node 120 may be comprised in a New Generation Radio Access Network.

The method may comprise the actions described below. In some embodiments some of the actions may be performed. In some embodiments all the actions may be performed. In FIG. 7, optional actions are indicated with a dashed box. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples.

The detailed description of some of the following corresponds to the same references provided above, in relation to the actions described for the wireless device 110, and will thus not be repeated here to simplify the description. For example, Abstract Syntax Notation One (ASN.1) examples of the different information elements signalled between the wireless device 110 and the radio network node 120 may be the same as those provided above.

Action 701

In the course of operations in the wireless communication network 100, the radio network node 120 may at some point, desire to obtain the location of the wireless device 110. In order to obtain the information in a more efficient way, with a simpler architecture and/or with a reduced latency, in this Action 701, the radio network node 120 may verify that location information can be retrieved within an acceptable latency. The verifying in this Action 701 may be performed in some embodiments wherein the radio network node 120 may have obtained the information about the flag indication or the PDCP Control PDU in Action 704. The verifying in this Action 701 may be performed before invoking a procedure to obtain wireless device location from Network LPP session before invoking a procedure to obtain the wireless device 110 location from a network LPP session.

In some embodiments, the radio network node 120 may verify that location information can be retrieved within an acceptable latency by requesting, e.g., via the DL link, the wireless device 110 to indicate whether or not it may have a capability of positioning measurements in an RRC procedure. In some of such embodiments, Action 702 may then be performed.

In some embodiments, the radio network node 120 may verify that location information can be retrieved within an acceptable latency by requesting, e.g., via the DL link, the wireless device 110 to indicate whether or not it may have an ongoing positioning session, e.g., an LPP session. In some of such embodiments, the radio network node 120 may then obtain the flag indication or the PDCP Control PDU in Action 704.

In some particular embodiments, the radio network node 120 may verify that location information can be retrieved within an acceptable latency by requesting the wireless device 110 to indicate whether or not it may have the capability of positioning measurements in an RRC procedure, and if no response is obtained, or the response is negative, as indicated by the “No” arrow in FIG. 7, the radio network node 120 may then verify that location information can be retrieved within an acceptable latency by requesting the wireless device 110 to indicate whether or not it may have an ongoing positioning session.

Action 702

In this Action 702, the radio network node 120 may obtain, from the wireless device 110, the capability indication indicating the capability of the wireless device 110 of positioning measurements in an RRC procedure. This Action 302 may be based on the request that the radio network node 120 may have sent to the wireless device 110 to indicate whether or not it may have the capability of positioning measurements in an RRC procedure in Action 702.

As a result of obtaining the capability indication in this Action 702, the radio network node 120 may then perform Action 703. Otherwise, in some embodiments wherein the radio network node 120 does not receive the capability indication, it may then perform Action 704, as described below, obtaining the flag indication or the PDCP Control PDU.

The obtaining in this Action 702 may be understood as receiving and may be performed e.g., via a UL link.

In some embodiments, the capability indication may be comprised in the MeasAndMobParameters information element.

Action 703

In some embodiments wherein the radio network node 120 may have obtained the capability indication from the wireless device 110, corresponding to the “Yes” option in FIG. 7, the radio network node 120 may, in this Action 703, initiate, the first location information request in the RRC Reconfiguration message.

Initiating may be understood as e.g., starting, triggering, or sending, e.g., via the DL link.

In some embodiments, the first location information request may be comprised in the MeasConfig information element.

Action 704

In this Action 704, the radio network node 120 receives, or obtains, from the wireless device 110 comprised in the wireless communication network 100, at least one of: i) the information about the first location information request sent by the radio network node 120 to the wireless device 110 in a Radio Resource Control Reconfiguration message in Action 703, and ii) the location procedure configuration. The location procedure configuration is one of: a) the flag indication and b) the PDCP Control PDU. The flag indication conveys to the radio network node 120, that the wireless device 110 has the ongoing positioning session. The flag indication is in the RRC message. The PDCP Control PDU conveys to the radio network node that the wireless device has an ongoing positioning session.

In the first group of embodiments, the information about the first location may be the measurement report. In some of these embodiments, the measurement report may be comprised in the MeasResults information element.

In some embodiments wherein the radio network node 120 may obtain the information about the first location information request in this Action 704, the radio network node 120 may have obtained the capability indication from the wireless device 110 in Action 702.

In some embodiments wherein the radio network node 120 may obtain the information about the first location information request in this Action 704, the radio network node 120 may have performed the verifying that location information can be retrieved within an acceptable latency of Action 701, for example by requesting the wireless device 110 to indicate whether or not it may have the capability of positioning measurements in an RRC procedure. In some of these embodiments, the radio network node 120 may have further obtained the capability indication from the wireless device 110 in Action 702, and may have then have initiated the first location information request in the RRC Reconfiguration message in Action 703.

In the second group of embodiments, the radio network node 120 may obtain the location procedure configuration in the PDCP Control PDU. In some of these embodiments, the location procedure configuration may be indicated via the PDU type field in the PDCP Control PDU.

In some embodiments wherein the radio network node 120 may obtain the location procedure configuration in the PDCP Control PDU in this Action 704, the radio network node 120 may have performed the verifying that location information can be retrieved within an acceptable latency of Action 701, for example by requesting the wireless device 110 to indicate whether or not it may have an ongoing positioning session.

Some embodiments herein will now be further described with some non-limiting examples. As mentioned earlier, embodiments herein may comprise two groups of embodiments. In the first group of embodiments, the NG-RAN, which may be understood to comprise the radio network node 120, may act as an LMC. In the second group of embodiments, the NG-RAN, which may be understood to comprise the radio network node 120, may act as an LCS. These two groups of embodiments will now be described further, with particular non-limiting examples, from the wireless device 110 perspective, from the NG-RAN perspective, e.g., the perspective of the radio network node 120, and in combined non-limiting examples. It may be understood that the detailed description of some of the following corresponds to the same references provided above, in relation to the actions described for the wireless device 110 and the radio network node 120, and will thus not be repeated here to simplify the description. For example, Abstract Syntax Notation One (ASN.1) examples of the different information elements signalled between the wireless device 110 and the radio network node 120 may be the same as those provided above.

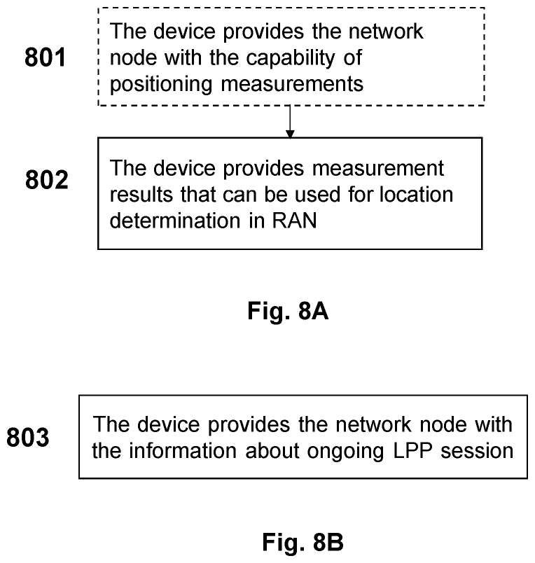

The method actions performed by the wireless device 110 for handling positioning of the wireless device 110 in the wireless communication network according to some embodiments will now be described with reference to a flowchart depicted in FIGS. 8A-8B, which depicts a non-limiting example of embodiments herein. Actions performed in some embodiments are marked with dashed boxes. The actions may be performed in any suitable order.

Wireless Device Side for NG-RAN as LMC.

Action 801. The wireless device 110 may provide the network node, such as the radio network node 120, in agreement with Action 601, with the capability of positioning measurements.

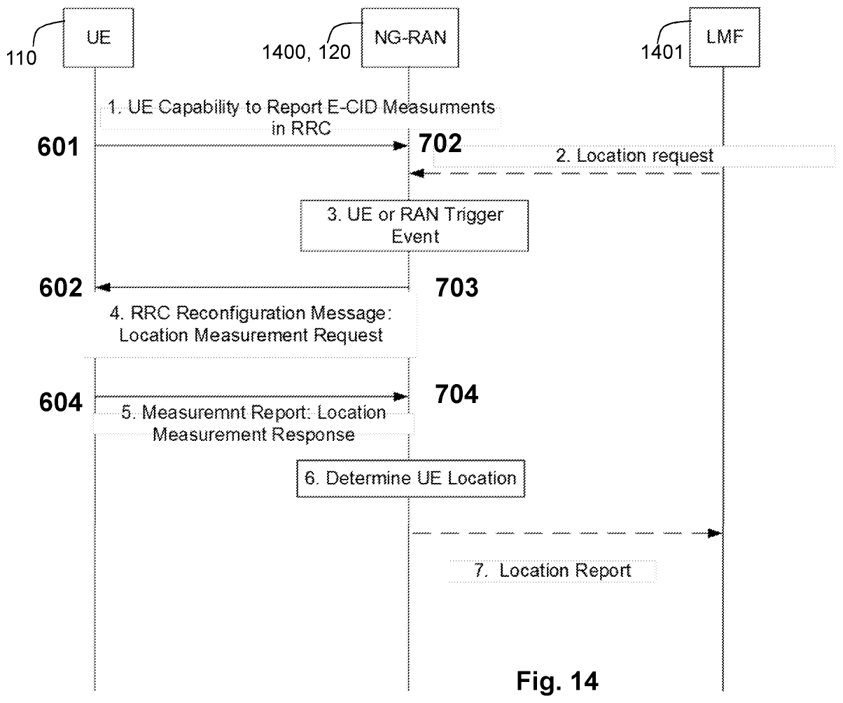

Action 802. The wireless device 110, in agreement with Action 604(i), further provides measurement results that can be used for location determination in the RAN, see FIG. 14.

Wireless Device Side for NG-RAN as LCS.

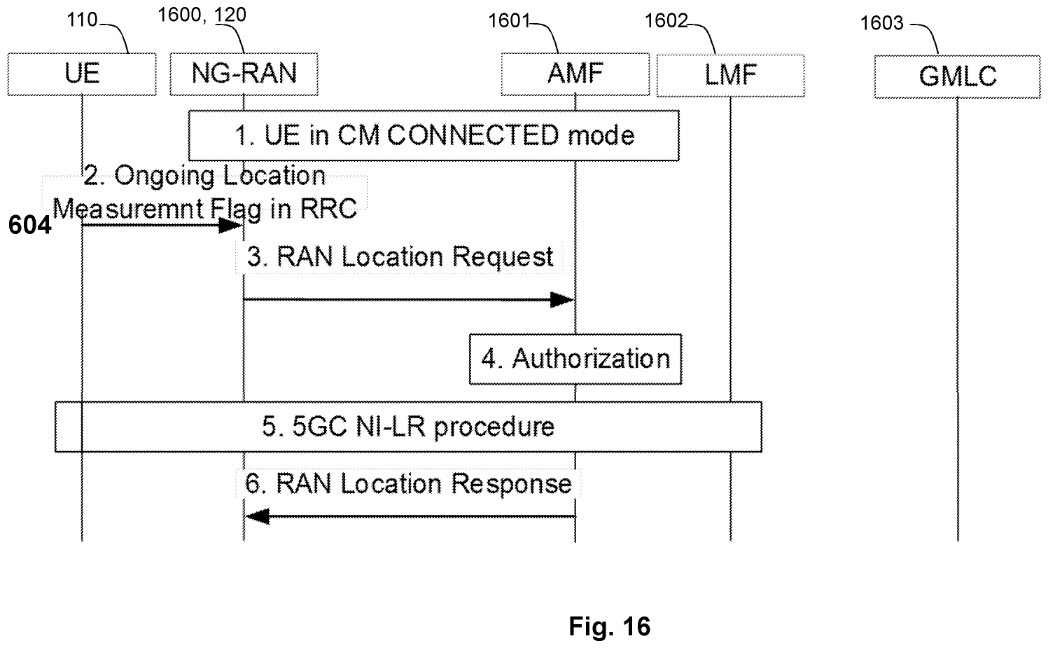

Action 803. The wireless device 110 may provide, in agreement with Action 604(ii), the radio network node 120 with the information about ongoing a LPP session, see FIG. 16.

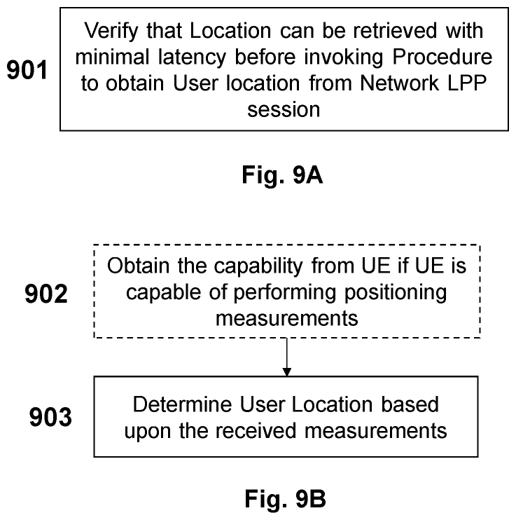

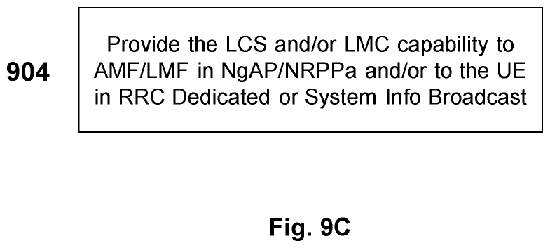

The method actions performed by the radio network node 120 for handling positioning of the wireless device 110 in the wireless communication network 100 according to embodiments will now be described with reference to a flowchart depicted in FIGS. 9A-9C. The actions do not have to be taken in the order stated below, but may be taken in any suitable order.

When NG-RAN as LCS:

Action 901. The radio network node 120, in agreement with Action 701, may verify that Location can be retrieved with minimal latency before invoking a procedure to obtain location of the wireless device 110 from Network LPP session.

When NG-RAN as LMC:

Action 902. The radio network node 120, in agreement with Action 702, receives or obtains from the wireless device 110 the capability from the wireless device 110 if the wireless device 110 is capable of performing positioning measurements.

Action 903. The radio network node 120 determines User Location based upon the received measurements in Action 704. This may be understood to result in a more flexible solution providing the wireless communication network 100 with improved performance.

When NG-RAN as LMC or LCS:

Action 904. In this example, the radio network node 120 may provide the LCS and/or LMC capability to an AMF and/or LMF in NgAP/NRPPa, and/or to the wireless device 110 in a RRC Dedicated or System Info Broadcast.

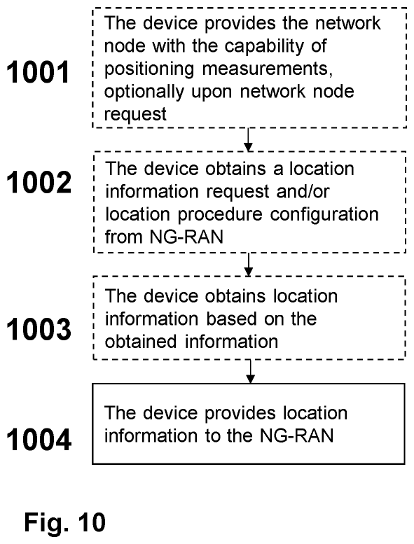

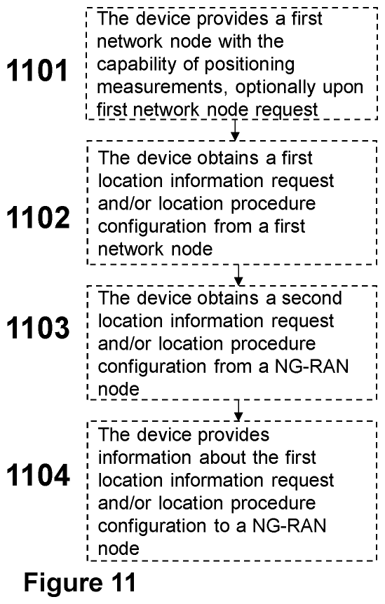

The method actions performed by the wireless device 110 for handling positioning of the wireless device 110 in the wireless communication network 100 according to some non-limiting examples of embodiments herein will now be described with reference to a flowcharts depicted in FIGS. 10-11. The actions may be performed in any suitable order. FIG. 10 depicts method actions from the UE side, that is, from the perspective of the wireless device 120, for NG-RAN as LMC. FIG. 11 depicts method actions from the UE side, that is, from the perspective of the wireless device 120, for NG-RAN as LCS.

When the Radio Network Node 120 is LMC:

Action 1001. The wireless device 110 may provide the network node, such as the radio network node 120, with the capability of positioning measurements, in agreement with Action 601, optionally upon network node request.

Action 1002. The wireless device 110 may obtain, in agreement with Action 602, a location information request, e.g., the first location information request, and/or a location procedure configuration, e.g., as comprised in the RRC Reconfiguration message, from the NG-RAN, such as the radio network node 120.

Action 1003. The wireless device 110 may obtain location information based on the obtained information. That is, the wireless device 110 may measure and collect positioning measurements.

Action 1004. The wireless device 110 may provide, in agreement with Action 604 (i), location information to the NG-RAN, e.g., report positioning measurements back to the radio network node 120.

When the Radio Network Node 120 is LCS:

Action 1101. The wireless device 110 may provide a first network node, with the capability of positioning measurements, optionally upon first network node request. In these examples, the first network node may be for example, the AMF, or the LMF.

Action 1102. The wireless device 110 may obtain a first location information request and/or location procedure configuration from the first network node such as a network node e.g. AMF node. The location procedure configuration may indicate how and what to measure. The first location information request in this non-limiting example is a location information request, which in this particular example may come first in the implementation of the method.

Action 1103. The wireless device 110 may then obtain, in agreement with Action 601, a second location information, that is request and/or location procedure configuration from a NG-RAN node such as the radio network node 120. The second location information request in this non-limiting example may be understood to correspond to the “first” location information request described in relation to Action 601 and Action 703, which in this particular example may come second in the implementation of the method.

Action 1104. The wireless device 110 may then provide, information about the first location information request and/or location procedure configuration, in agreement with Action 604(i) to the radio network node 120, e.g. a flag such as the flag described earlier, or the PDCP Control PDU.

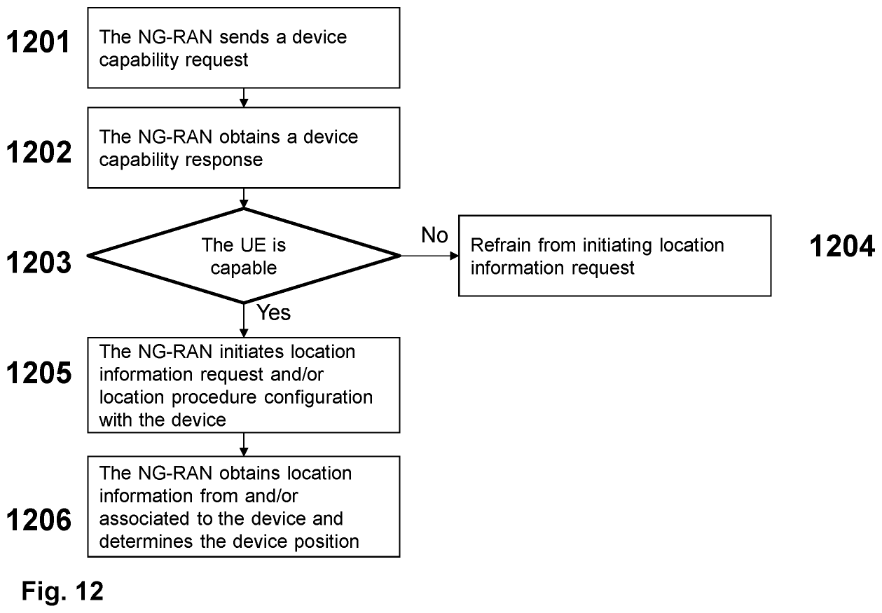

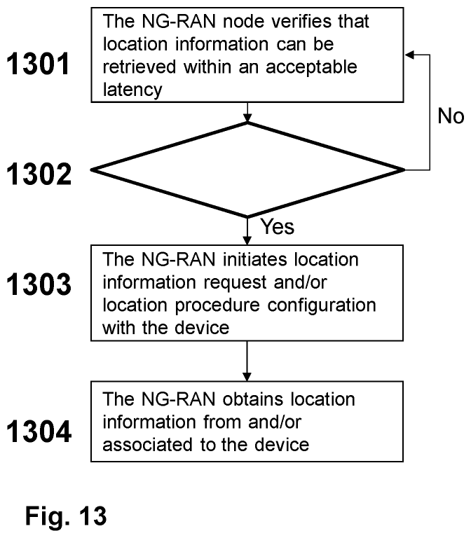

The method actions performed by the radio network node 120 for handling positioning of the wireless device 110 in the wireless communication network according to some non-limiting examples of embodiments herein will now be described with reference to a flowchart depicted in FIGS. 12-13. The actions may be performed in any suitable order. FIG. 12 depicts method actions from the NG-RANside, e.g., from the perspective of the radio network node 110, for NG-RAN as LMC. FIG. 13 depicts method actions from the NG-RANside, e.g., from the perspective of the radio network node 110, for NG-RAN as LCS.

When the NG-RAN as LMC:

Action 1201. The radio network node 120 may send a device capability request to the wireless device 110, as an example implementation of Action 701.

Action 1202. The radio network node 120 may obtain, in agreement with Action 701, a device capability response from the wireless device 110.

Action 1203. The radio network node 120 may determine whether the wireless device 110 is capable of performing positioning measurements.

Action 1204. In case the wireless device 110 is not capable, the radio network node 120 may refrain from initiating location information request.

Action 1205. In case the wireless device is capable, the radio network node 120 may initiate, in agreement with Action 703, location information request, e.g., the first location information request of Action 703, and/or location procedure configuration with the wireless device 110.

Action 1206. The radio network node 120 may then obtain, in agreement with Action 704(i), location information from and/or associated to the wireless device, and may determine the position of the wireless device 110 based on the location information.

When the NG-RAN as LCS:

Action 1301. The radio network node 120 may verify, in agreement with Action 701, that location information can be retrieved within an acceptable latency.

Action 1302. The radio network node 120 may initiate, in agreement with Action 703, location information request and/or location procedure configuration with the wireless device 110.

Action 1303. The radio network node 120 may obtain, in agreement with Action 704(ii), location information from and/or associated to the wireless device 110, e.g., the flag indication or the PDCP Control PDU.

Some further non-limiting examples for the first group of embodiments and the second group of embodiments herein will now be described in the form of signalling diagrams between the wireless device 110, the radio network node 120, with optionally other nodes in the wireless communication network 100.

First Group of Embodiments: NG-RAN as LMC

A first non-limiting example of the first group of embodiments is depicted with the new sequence flow shown in FIG. 14. At 1, the wireless device 110, represented as “UE”, sends, in accordance with Action 601, a capability report providing information on whether the wireless device 110 is capable of performing measurements for Positioning/Location Estimations. More details for wireless device capability has been provided in the ASN.1 example above for the MeasAndMobParameters information element. The capability indication is obtained by the NG-RAN 1400, e.g., by the radio network node 120, according to Action 702. In some examples, the NG-RAN may receive a location request, at 2, from a network node such as an LMF node 1401. In the NG-RAN, e.g., an gNB such as the radio network node 120, if for any reason positioning of the wireless device 110 is desired, that is, if positioning is triggered at the radio network node 120 at 3, a configuration message such as a radio resource control (RRC) Reconfiguration message is sent at 4, in agreement with Action 703, which includes what sort of measurement from the wireless device 110 may be required. The existing MeasConfig as part of RRC Reconfiguration may be extended with an information element, as exemplified earlier, or a new Positioning Specific MeasConfig may be introduced. In agreement with Action 602, the wireless device 110 obtains the first location information request, and at 5, in agreement with Action 604 (i), the wireless device 110 provides the information about the first location information request, in the form of a measurement report, which the NG-RAN 1400 obtains in agreement with Action 704 (i). Further, once the radio network node 120 may have determined the location of the wireless device 110 at 6, the location may be reported, at 7, to a network node such as the LMF node 1401 via NRPPa, if requested by the LMF node 1401. If the location determination is initiated by NG-RAN, a location report may optionally be sent to an LMF node 1401, that is, a network node.

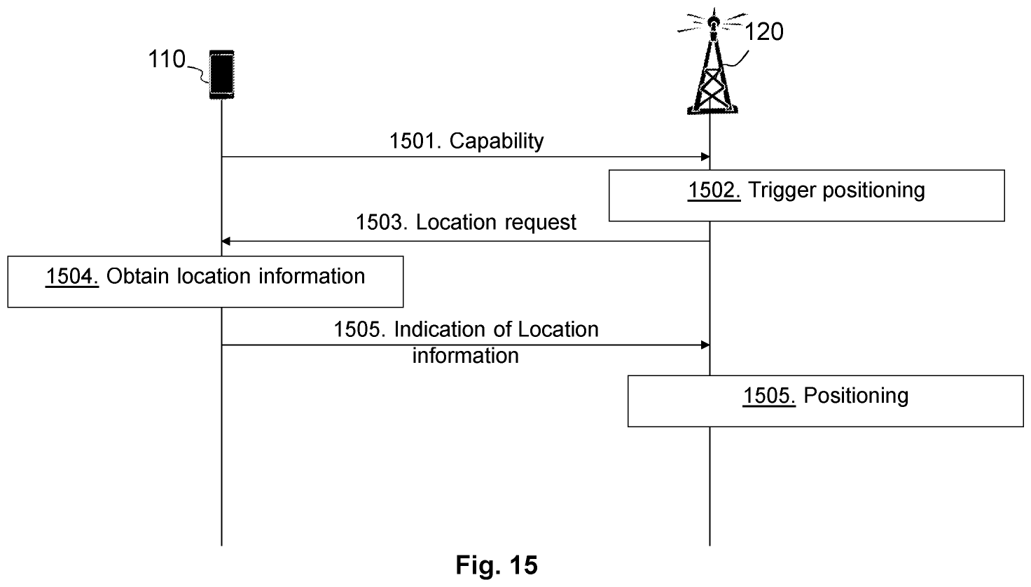

FIG. 15 is a combined flowchart and signalling scheme according to a second non-limiting example of the first group of embodiments herein.

Action 1501. The wireless device 110 may transmit, in agreement with Action 601, capability information to the radio network node 120, wherein the capability information may comprise information about whether the wireless device 110 can determine position or at least perform some measurements to facilitate positioning. That is, the wireless device 110 may provide the radio network node 120 with the capability indication indicating capability of positioning measurements.

Action 1502. The radio network node 120 may trigger a positioning of the wireless device 110, e.g. receive a request for positioning the wireless device 110 from a network node such as an AMF node.

Action 1503. The radio network node 120 may then e.g., based on the capability information and/or request, transmit, in agreement with Action 703, a location request such as a measurement request with an indication indicating configuration for performing one or more measurements. That is, the radio network node 120 may inform the wireless device 110 about what sort of measurement the wireless device 110 may be required to perform.

Action 1504. The wireless device 110 obtains location information such as measurements, that is, performs one or more measurements as requested by the radio network node 120.

Action 1505. The wireless device 110, in agreement with Action 704(i), transmits the measurements or a value of the measurements, back to the radio network node 120, e.g. gNB, or AMF node.

Action 1506. The radio network node 120 may then determine position of the wireless device 110 based on the received measurements or value of measurements.

Second Group of Embodiments: NG-RAN as LCS

A separate non-limiting example of the second group of embodiments is shown in FIG. 16. At 1, the wireless device 110, depicted as “UE”, is in CM-CONNECTED state, to request, the AMF 1601 to report the current location of the wireless device 110. At 2, the wireless device 110 includes, in an RRC message, the flag indication conveying to the radio network node 120, such as NG-RAN 1600, that it has an ongoing positioning session with a network node, such as the LMF node 1602, or that it knows its location. An example of such a flag has been shown above with an ASN.1 example, where the wireless device 110 using RRC measurement Results, provides, in agreement with Action 604(ii), the information about whether an LTE positioning protocol (LPP) Session is active or not. In such cases, when LPP session is active, if the radio network node 120 needs the location, it can initiate, at 3, the procedure to fetch the location from the AMF node 1601 via a RAN location Request. At 4, the AMF 1601 processes the authorization. At 5, the 5GC performs the Network Initiated Location Request (NI-LR) procedure, with involvement of the LMF 1602, and at 6, the AMF 1601 provides the RAN Location Response to the NG-RAN 1600, e.g., to the radio network node 120. The GMLC 1603 may be understood as an external client, e.g., an external LCS, which may invoke positioning, or request that it may need to get a position of certain UE. The main advantage of such an example may be understood to be that it would minimize the latency. Also, it may be understood to have less impact in the radio network node 120 without the having the need to estimate the user location.

In another non-limiting example of the second group of embodiments, the radio network node 120, or the NG-RAN 1600, before initiating the procedure to fetch the location of the wireless device 110 from the AMF 1601 and/or the LMF 1602, can also check, in agreement with Action 701, with the wireless device 110, via an RRC message, or with the use of a Packet Data Convergence Protocol (PDCP) Control protocol data unit (PDU), such as the PDCP Control PDU described earlier, whether there is any ongoing Positioning session. The wireless device 110 may respond correspondingly with a PDCP Control PDU acknowledgment or non-acknowledgment ACK/NACK or via RRC message, in agreement with Action 704(ii). A new PDCP control PDU may also be defined for this as shown in FIG. 17. As depicted in the figure, the first octet (Oct 1) of the PDCP Control PDU comprises a Data/Control (D/C) field 1701, a PDU Type field 1702, a new Location Session (LS) field 1703, and a first Reserved (R) field 1704, a second R field 1705 and a third R field 1706. The number of bits is schematically indicated in the top of the figure. The one bit LS field 1703, for example, may be used by the network node 120 to check with the wireless device 110, in agreement with Action 701, whether the wireless device 110 has an active Location session. The wireless device 110 may also respond, using the same PDCP control PDU, or by using RRC message with a flag set to true/false, in agreement with Action 604(ii). The main purpose for this may be understood to be to ensure that latency may be minimized. Otherwise, the LMF node 1602 may have to initiate the LPP protocol to get the wireless device location, that is, the location of the wireless device 110, which may further take longer duration.

In further examples of embodiments herein, the NG-RAN 1600 LCS may initiate positioning via the AMF 1601 to trigger a location node, such as an Evolved Serving Mobile Location Center (E-SM LC) and/or the LMF 1602, to provide the wireless device 110 with assistance data for wireless device-based positioning via LPP. The configuration from the LMF 1602 and/or the E-SMLC to the wireless device 110 may, in such examples, further include a configuration for the wireless device 110 to report the estimated positions, in particular if they are periodic, via RRC. The radio network node 120 can add the estimated positions to a minimization of drive tests (MDT) node, or forward to the LMF node 1602.

In another example of embodiments herein, the radio network node 120 with LCS and/or LMC capability may indicate the LCS and/or LMC capability to other public land mobile network (PLMN) Nodes, such as AMF and/or LM F. Such LCS and/or LMC capability can also be informed to the wireless device 110 in a dedicated RRC message, or using System Information Broadcast.

Embodiments herein may be understood to provide a simplified positioning architecture and a RAN procedure to cater NG-RAN to be LCS and LMC.

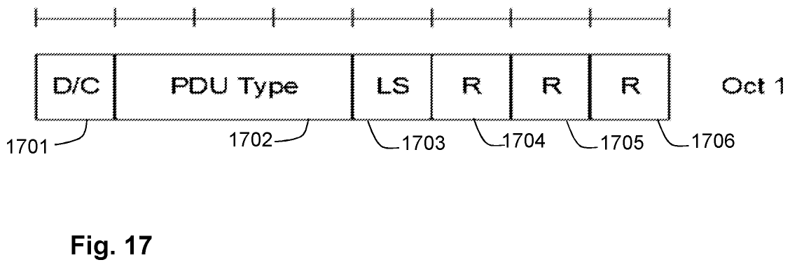

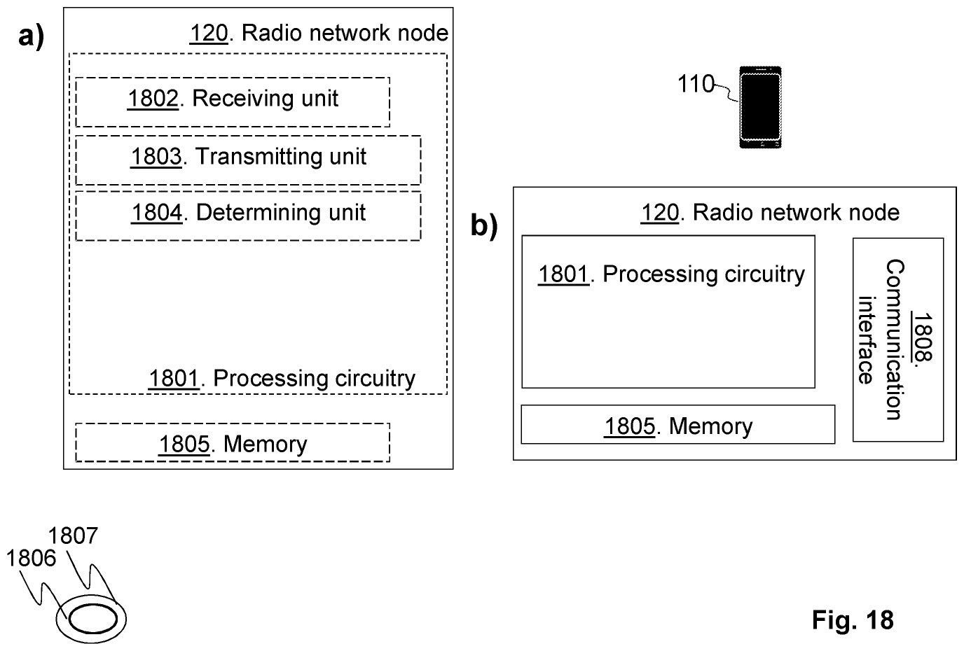

FIG. 18 is a block diagram depicting two examples, in panel a) and b), respectively, of the radio network node 120 for handling positioning of wireless devices, such as the wireless device 110, in the wireless communication network 100 according to embodiments herein.

In some embodiments, the radio network node 120 may be configured to be comprised in a New Generation Radio Access Network.

As depicted in FIG. 18, the radio network node 120 may comprise processing circuitry 1801, e.g. one or more processors, configured to perform the methods herein.

In some examples, such as those depicted in panel a), the processing circuitry 1801 may comprise a number of units, as described below.

The radio network node 120 may comprise a receiving unit 1802, e.g. a receiver module or a transceiver module. The radio network node 120, the processing circuitry 1801, and/or the receiving unit 1802 is configured to obtain, from the wireless device 110 configured to be comprised in the wireless communication network 100, at least one of: i) the information about the first location information request configured to be sent by the radio network node 120 to the wireless device 110 in the RRC Reconfiguration message, and ii) the location procedure configuration. The location procedure configuration is configured to be one of: a) the flag indication and b) the PDCP Control PDU. The flag indication is configured to convey to the radio network node 120, that the wireless device 110 has the ongoing positioning session. The flag indication is configured to be in an RRC message. The PDCP Control PDU is configured to convey to the radio network node that the wireless device has an ongoing positioning session.

In some embodiments, the radio network node 120 may be configured to obtain the information about the first location information request.

In some embodiments, the information about the first location may be configured to be the measurement report.

In some embodiments, the measurement report may be configured to be comprised in the MeasResults information element.

In some embodiments, the radio network node 120 may be configured to obtain the location procedure configuration.

In some embodiments, the radio network node 120 may be configured to obtain the location procedure configuration in the PDCP Control PDU.

In some embodiments, the location procedure configuration may be configured to be indicated via a PDU type field in the PDCP Control PDU.

In some embodiments, wherein the radio network node 120 is configured to obtain the information about the first location information request, the radio network node 120, the processing circuitry 1801, and/or the receiving unit 1802 may be further configured to obtain, from the wireless device 110, the capability indication configured to indicate the capability of the wireless device 110 of positioning measurements in an RRC procedure.

In some embodiments, the capability indication may be configured to be comprised in the MeasAndMobParameters information element.

The radio network node 120 may comprise a transmitting unit 1803. The radio network node 120, the processing circuitry 1801, and/or the transmitting unit 1803 may be further configured to initiate, the first location information request in the RRC Reconfiguration message.

In some embodiments, the first location information request may be configured to be comprised in the MeasConfig information element.

The radio network node 120 may comprise a determining unit 1804. In some embodiments, e.g., wherein the radio network node 120 may be further configured to obtain the flag indication or the PDCP Control PDU, the radio network node 120, the processing circuitry 1801, and/or the determining unit 1804 may be configured to verify that location information can be retrieved within an acceptable latency.

The radio network node 120 further comprises a memory 1805. The memory comprises one or more units to be used to store data on, such as indications, configuration indications, measurements, capabilities of wireless devices, applications to perform the methods disclosed herein when being executed, and similar.

The methods according to the embodiments described herein for the radio network node 120 may be respectively implemented by means of e.g. a computer program product 1806 or a computer program, comprising instructions, i.e., software code portions, which, when executed on at least one processor, cause the at least one processor to carry out the actions described herein, as performed by the radio network node 120. The computer program product 1806 may be stored on a computer-readable storage medium 1807, e.g. a disc, a universal serial bus (USB) stick or similar. The computer-readable storage medium 1807, having stored thereon the computer program product, may comprise the instructions which, when executed on at least one processor, cause the at least one processor to carry out the actions described herein, as performed by the radio network node 120. In some embodiments, the computer-readable storage medium may be a transitory or a non-transitory computer-readable storage medium.

In some examples of embodiments herein, the radio network node 120 may comprise the receiving unit 1802, e.g. a receiver module or a transceiver module. In some of such examples, the radio network node 120, the processing circuitry 1801, and/or the receiving unit 1802 may be configured to receive from the wireless device 110 capability indication indicating capability of the wireless device to perform positioning measurements or not.

In some examples of embodiments herein, the radio network node 120 may comprise the transmitting unit 1803. The radio network node 120, the processing circuitry 1801, and/or the transmitting unit 1803 may be configured to transmit configuration data in e.g. a measurement request with an indication indicating configuration for performing one or more measurements for positioning the wireless device 110.

In some examples of embodiments herein, the he radio network node 120, the processing circuitry 1801, and/or the receiving unit 1802 may be configured to receive from the wireless device 110 one or more measurement indications indicating positioning measurements. The radio network node 120, the processing circuitry 1801, and/or the receiving unit 1802 may be configured to receive from the wireless device 110 indication of present location measurements e.g. an indication of an active location session. The radio network node 120, the processing circuitry 1801, and/or the transmitting unit 1803 may be configured to transmit, triggered by receiving the indication of an active session, to the network node such as an AMF node, a request for location of the wireless device 110.

In some examples of embodiments herein, the radio network node 120 may comprise the determining unit 1807. The radio network node 120, the processing circuitry 1801, and/or the determining unit 1807 may be configured to determine position of the wireless device from e.g. the received measurements or indications of measurements.

In other embodiments, the radio network node 120 may comprise the following arrangement depicted in panel b) of FIG. 18. The radio network node 120 may comprise the processing circuitry 1901, the memory 1904 and a communication interface 1808, which may comprise a radio circuitry, which may comprise e.g., a receiving port and a sending port. The processing circuitry 1901 may be configured to, or operable to, perform the method actions according to FIG. 7, and/or any of FIGS. 9A, 9B, 9C, 12, 13, and/or 14-17 in a similar manner as that described in relation to FIG. 18, panel a). The radio circuitry may be configured to set up and maintain at least a wireless connection with the wireless device 110, and any of the other network nodes, such as the AMF 1601, and/or the LMF 1401, 1602.

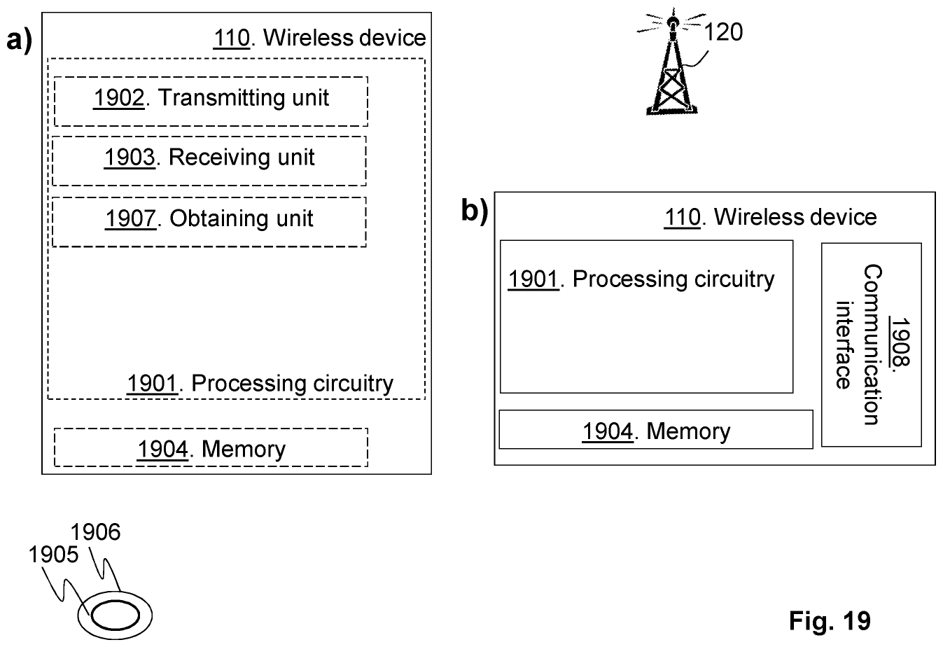

FIG. 19 is a block diagram depicting two examples, in panel a) and b), respectively, of the wireless device 110 for handling positioning of the wireless device 110 in the wireless communication network 100, e.g. enabling positioning or performing positioning or partly performing measurements for positioning the wireless device 110 according to embodiments herein.

In some embodiments, the wireless device 110 may be configured to be comprised in a New Generation Radio Access Network.

As depicted in FIG. 19, the wireless device 110 may comprise processing circuitry 1901, such as one or more processors, configured to perform methods herein.

In some examples, such as those depicted in panel a), the processing circuitry 1901 may comprise a number of units, as described below.

The wireless device 110 may comprise a transmitting unit 1902, e.g. a transmitter module or transceiver module. The wireless device 110, the processing circuitry 1901, and/or the transmitting unit 1902 is configured to provide, to the radio network node 120 comprised in the wireless communication network 100, at least one of: i) the information about the first location information request configured to be obtained from the radio network node 120 in the RRC Reconfiguration message, and ii) the location procedure configuration. The location procedure configuration is configured to be one of: a) the flag indication and b) the PDCP Control PDU. The flag indication is configured to convey to the radio network node 120 that the wireless device 110 has the ongoing positioning session. The flag indication is configured to be in an RRC message. The PDCP Control PDU is configured to convey to the radio network node that the wireless device has an ongoing positioning session.

In some embodiments, the information about the first location may be configured to be the measurement report.

In some embodiments, the measurement report may be configured to be comprised in the MeasResults information element.

In some embodiments, the wireless device 110 may be configured to provide the location procedure configuration in the PDCP Control PDU.

In some embodiments, the location procedure configuration may be configured to be indicated via the PDU type field in the PDCP Control PDU.

In some embodiments, wherein the wireless device 110 may be configured to provide the information about the first location information request, the wireless device 110, the processing circuitry 1901, and/or the transmitting unit 1902 may be further configured to provide, to the radio network node 120, the capability indication configured to indicate the capability of the wireless device 110 of positioning measurements in an RRC procedure.

In some embodiments, the capability indication may be configured to be comprised in the MeasAndMobParameters information element.

The wireless device 110 may comprise a receiving unit 1903 e.g. a receiver module or transceiver module. In some embodiments, wherein the wireless device 110 may be configured to provide the information about the first location information request, the wireless device 110 The wireless device 110, the processing circuitry 1901, and/or the receiving unit 1903 may be further configured to obtain, the first location information request in the RRC Reconfiguration message.

In some embodiments, the first location information request may be configured to be comprised in the MeasConfig information element.

In some embodiments, wherein the wireless device 110 is configured to provide 604 the location procedure configuration, the wireless device 110, the processing circuitry 1901, and/or the obtaining unit 1904 may be configured to obtain the second location information request from the New Generation Radio Access Network node.

The wireless device 110 further comprises a memory 1904. The memory comprises one or more units to be used to store data on, such as indications, configuration indications, measurements, capability, applications to perform the methods disclosed herein when being executed, and similar.

The methods according to the embodiments described herein for the wireless device 110 are respectively implemented by means of e.g. a computer program product 1905 or a computer program, comprising instructions, i.e., software code portions, which, when executed on at least one processor, cause the at least one processor to carry out the actions described herein, as performed by the wireless device 110. The computer program product 1905 may be stored on a computer-readable storage medium 1906, e.g. a disc, a USB stick or similar. The computer-readable storage medium 1906, having stored thereon the computer program product, may comprise the instructions which, when executed on at least one processor, cause the at least one processor to carry out the actions described herein, as performed by the wireless device 110. In some embodiments, the computer-readable storage medium may be a transitory or a non-transitory computer-readable storage medium.

In some examples of embodiments herein, the wireless device 110 may comprise the transmitting unit 1902, e.g. a transmitter module or transceiver module. In some of such examples, the wireless device 110, the processing circuitry 1901, and/or the transmitting unit 1902 may be configured to transmit to the radio network node 120 a capability indication indicating capability of performing positioning measurements.

In some examples of embodiments herein, the wireless device 110 may comprise the receiving unit 1903 e.g. a receiver module or transceiver module. In some of such examples, the wireless device 110, the processing circuitry 1901, and/or the receiving unit 1903 may be configured to receive configuration data from the radio network node 120 e.g. in a measurement request with an indication indicating configuration for performing one or more measurements.

In some examples of embodiments herein, the wireless device 110 may comprise an obtaining unit 1907 e.g. a measurement module. In some of such examples, the wireless device 110, the processing circuitry 1901, and/or the obtaining unit 1904 may be configured to obtain measurements e.g., RSSI, RSRP, RSRQ performed as configured in the received configuration data.

In some examples of embodiments herein, the wireless device 110, the processing circuitry 1901, and/or the transmitting unit 1902 may be configured to transmit to the radio network node 120 the obtained measurements and/or results of the obtained measurements. The wireless device 110, the processing circuitry 1901, and/or the transmitting unit 1902 may be configured to transmit to the radio network node 120 a present indication, wherein the present indication, e.g., the flag indication, may be indicating ongoing location measurements.

In other embodiments, the wireless device 110 may comprise the following arrangement depicted in panel b) of FIG. 19. The wireless device 110 may comprise the processing circuitry 1901, the memory 1904 and a communication interface 1908, which may comprise a radio circuitry, which may comprise e.g., a receiving port and a sending port. The processing circuitry 1901 may be configured to, or operable to, perform the method actions according to FIG. 6, and/or any of FIGS. 8A, 8B, 10, 11, and/or 14-17 in a similar manner as that described in relation to FIG. 19, panel a). The radio circuitry may be configured to set up and maintain at least a wireless connection with the radio network node 120, the NG-RAN node 1400, 1600, and any of the other network nodes, such as the AMF 1601, and/or the LMF 1401, 1602.

In some embodiments a more general term “radio network node” is used and it can correspond to any type of radio-network node or any network node, which communicates with a wireless device and/or with another network node. Examples of network nodes are NodeB, MeNB, SeNB, a network node belonging to Master cell group (MCG) or Secondary cell group (SCG), base station (BS), multi-standard radio (MSR) radio node such as MSR BS, eNodeB, network controller, radio-network controller (RNC), base station controller (BSC), relay, donor node controlling relay, base transceiver station (BTS), access point (AP), transmission points, transmission nodes, Remote radio Unit (RRU), Remote Radio Head (RRH), nodes in distributed antenna system (DAS), mobility management entity, AMF node, core network node etc.

In some embodiments the non-limiting term wireless device or user equipment (UE) is used and it refers to any type of wireless device communicating with a network node and/or with another wireless device in a cellular or mobile communication system. Examples of UE are target device, device to device (D2D) UE, proximity capable UE, a.k.a. Proximity Services (ProSe) UE, machine type UE or UE capable of machine to machine (M2M) communication, Tablet, mobile terminals, smart phone, laptop embedded equipped (LEE), laptop mounted equipment (LME), USB dongles etc.

Embodiments are applicable to any RAT or multi-RAT systems, where the wireless device receives and/or transmit signals, e.g., data, e.g., New Radio (NR), Wi-Fi, Long Term Evolution (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

As will be readily understood by those familiar with communications design, that functions means or units may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware and/or program or application data. Other hardware, conventional and/or custom, may also be included. Designers of communications devices will appreciate the cost, performance, and maintenance trade-offs inherent in these design choices.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

According to a particular aspect of examples herein, the object to provide a mechanism to in an efficient manner enable positioning of a wireless device in a wireless communication network may be achieved, by a method wherein the radio network node may trigger a positioning of the wireless device, e.g. receive a request for positioning the wireless device from a network node such as an AMF node. The radio network node may then e.g. based on capability information of the wireless device, transmit a location request such as a measurement request with an indication indicating configuration for performing one or more measurements. The radio network node may further receive indications or values of the measurements from the wireless device. The radio network node may then determine position of the wireless device taking the indications or values of the measurements into account.

According to another particular aspect of examples herein, the object to provide a mechanism to in an efficient manner enable positioning of a wireless device in a wireless communication network may be by a method wherein the wireless device may transmit capability information to the radio network node, wherein the capability information may comprise information whether the wireless device may determine position or at least perform some measurements to facilitate positioning. The wireless device may further receive a location request such as a measurement request with an indication indicating configuration for performing one or more measurements. The wireless device may then obtain location information such as measurements, that is, it may perform one or more measurements as requested by the radio network node. The wireless device may then transmit the measurements or value of measurements back to the radio network node, e.g. gNB or AMF node.

The wireless device may in some embodiments transmit a present indication, wherein the present indication may be indicating ongoing location measurements.

It is furthermore provided herein a computer program product comprising instructions, which, when executed on at least one processor, cause the at least one processor to carry out any of the methods above, as performed by the radio network node or the wireless device. It is additionally provided herein a computer-readable storage medium, having stored thereon a computer program product comprising instructions which, when executed on at least one processor, cause the at least one processor to carry out the method according to any of the methods above, as performed by the radio network node or the wireless device.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

### Further Extensions And Variations

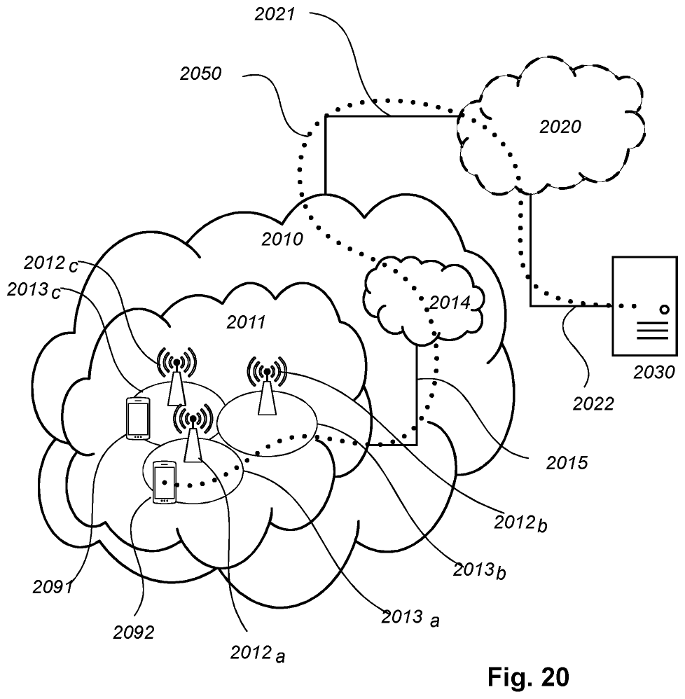

FIG. 20: Telecommunication network connected via an intermediate network to a host computer in accordance with some embodiments

With reference to FIG. 20, in accordance with an embodiment, a communication system includes telecommunication network 2010, such as a 3GPP-type cellular network, which comprises access network 2011, such as a radio access network, and core network 2014. Access network 2011 comprises a plurality of base stations 2012a, 2012b, 2012c, such as NBs, eNBs, gNBs or other types of wireless access points being examples of the radio network node 120 above, each defining a corresponding coverage area 2013a, 2013b, 2013c. Each base station 2012a, 2012b, 2012c is connectable to core network 2014 over a wired or wireless connection 2015. A first UE 2091 located in coverage area 2013c is configured to wirelessly connect to, or be paged by, the corresponding base station 2012c. A second UE 2092 in coverage area 2013a is wirelessly connectable to the corresponding base station 2012a. While a plurality of UEs 2091, 2092 are illustrated in this example being examples of the wireless device 110 above, the disclosed embodiments are equally applicable to a situation where a sole UE is in the coverage area or where a sole UE is connecting to the corresponding base station 2012.

Telecommunication network 2010 is itself connected to host computer 2030, which may be embodied in the hardware and/or software of a standalone server, a cloud-implemented server, a distributed server or as processing resources in a server farm. Host computer 2030 may be under the ownership or control of a service provider, or may be operated by the service provider or on behalf of the service provider. Connections 2021 and 2022 between telecommunication network 2010 and host computer 2030 may extend directly from core network 2014 to host computer 2030 or may go via an optional intermediate network 2020. Intermediate network 2020 may be one of, or a combination of more than one of, a public, private or hosted network; intermediate network 2020, if any, may be a backbone network or the Internet; in particular, intermediate network 2020 may comprise two or more sub-networks (not shown).

The communication system of FIG. 20 as a whole enables connectivity between the connected UEs 2091, 2092 and host computer 2030. The connectivity may be described as an over-the-top (OTT) connection 2050. Host computer 2030 and the connected UEs 2091, 2092 are configured to communicate data and/or signalling via OTT connection 2050, using access network 2011, core network 2014, any intermediate network 2020 and possible further infrastructure (not shown) as intermediaries. OTT connection 2050 may be transparent in the sense that the participating communication devices through which OTT connection 2050 passes are unaware of routing of uplink and downlink communications. For example, base station 2012 may not or need not be informed about the past routing of an incoming downlink communication with data originating from host computer 2030 to be forwarded (e.g., handed over) to a connected UE 2091. Similarly, base station 2012 need not be aware of the future routing of an outgoing uplink communication originating from the UE 2091 towards the host computer 2030.

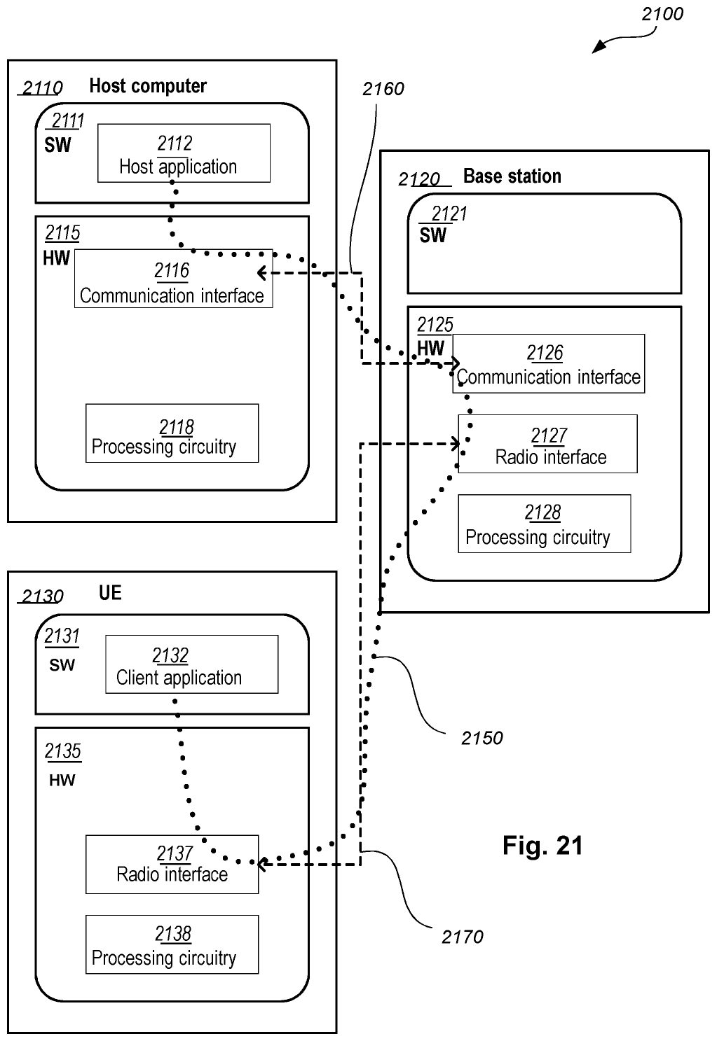

FIG. 21: Host computer communicating via a base station with a user equipment over a partially wireless connection in accordance with some embodiments

Example implementations, in accordance with an embodiment, of the UE, base station and host computer discussed in the preceding paragraphs will now be described with reference to FIG. 21. In communication system 2100, host computer 2110 comprises hardware 2115 including communication interface 2116 configured to set up and maintain a wired or wireless connection with an interface of a different communication device of communication system 2100. Host computer 2110 further comprises processing circuitry 2118, which may have storage and/or processing capabilities. In particular, processing circuitry 2118 may comprise one or more programmable processors, application-specific integrated circuits, field programmable gate arrays or combinations of these (not shown) adapted to execute instructions. Host computer 2110 further comprises software 2111, which is stored in or accessible by host computer 2110 and executable by processing circuitry 2118. Software 2111 includes host application 2112. Host application 2112 may be operable to provide a service to a remote user, such as UE 2130 connecting via OTT connection 2150 terminating at UE 2130 and host computer 2110. In providing the service to the remote user, host application 2112 may provide user data which is transmitted using OTT connection 2150.

Communication system 2100 further includes base station 2120 provided in a telecommunication system and comprising hardware 2125 enabling it to communicate with host computer 2110 and with UE 2130. Hardware 2125 may include communication interface 2126 for setting up and maintaining a wired or wireless connection with an interface of a different communication device of communication system 2100, as well as radio interface 2127 for setting up and maintaining at least wireless connection 2170 with UE 2130 located in a coverage area (not shown in FIG. 21) served by base station 2120. Communication interface 2126 may be configured to facilitate connection 2160 to host computer 2110. Connection 2160 may be direct or it may pass through a core network (not shown in FIG. 21) of the telecommunication system and/or through one or more intermediate networks outside the telecommunication system. In the embodiment shown, hardware 2125 of base station 2120 further includes processing circuitry 2128, which may comprise one or more programmable processors, application-specific integrated circuits, field programmable gate arrays or combinations of these (not shown) adapted to execute instructions. Base station 2120 further has software 2121 stored internally or accessible via an external connection.

Communication system 2100 further includes UE 2130 already referred to. It's hardware 2135 may include radio interface 2137 configured to set up and maintain wireless connection 2170 with a base station serving a coverage area in which UE 2130 is currently located. Hardware 2135 of UE 2130 further includes processing circuitry 2138, which may comprise one or more programmable processors, application-specific integrated circuits, field programmable gate arrays or combinations of these (not shown) adapted to execute instructions. UE 2130 further comprises software 2131, which is stored in or accessible by UE 2130 and executable by processing circuitry 2138. Software 2131 includes client application 2132. Client application 2132 may be operable to provide a service to a human or non-human user via UE 2130, with the support of host computer 2110. In host computer 2110, an executing host application 2112 may communicate with the executing client application 2132 via OTT connection 2150 terminating at UE 2130 and host computer 2110. In providing the service to the user, client application 2132 may receive request data from host application 2112 and provide user data in response to the request data. OTT connection 2150 may transfer both the request data and the user data. Client application 2132 may interact with the user to generate the user data that it provides.

It is noted that host computer 2110, base station 2120 and UE 2130 illustrated in FIG. 21 may be similar or identical to host computer 2030, one of base stations 2012a, 2012b, 2012c and one of UEs 2091, 2092 of FIG. 20, respectively. This is to say, the inner workings of these entities may be as shown in FIG. 21 and independently, the surrounding network topology may be that of FIG. 20.

In FIG. 21, OTT connection 2150 has been drawn abstractly to illustrate the communication between host computer 2110 and UE 2130 via base station 2120, without explicit reference to any intermediary devices and the precise routing of messages via these devices. Network infrastructure may determine the routing, which it may be configured to hide from UE 2130 or from the service provider operating host computer 2110, or both. While OTT connection 2150 is active, the network infrastructure may further take decisions by which it dynamically changes the routing (e.g., on the basis of load balancing consideration or reconfiguration of the network).

Wireless connection 2170 between UE 2130 and base station 2120 is in accordance with the teachings of the embodiments described throughout this disclosure. One or more of the various embodiments improve the performance of OTT services provided to UE 2130 using OTT connection 2150, in which wireless connection 2170 forms the last segment. More precisely, the teachings of these embodiments may improve the latency since the signalling may be more efficient and thereby provide benefits such as reduced waiting time and better responsiveness.

A measurement procedure may be provided for the purpose of monitoring data rate, latency and other factors on which the one or more embodiments improve. There may further be an optional network functionality for reconfiguring OTT connection 2150 between host computer 2110 and UE 2130, in response to variations in the measurement results. The measurement procedure and/or the network functionality for reconfiguring OTT connection 2150 may be implemented in software 2111 and hardware 2115 of host computer 2110 or in software 2131 and hardware 2135 of UE 2130, or both. In embodiments, sensors (not shown) may be deployed in or in association with communication devices through which OTT connection 2150 passes; the sensors may participate in the measurement procedure by supplying values of the monitored quantities exemplified above, or supplying values of other physical quantities from which software 2111, 2131 may compute or estimate the monitored quantities. The reconfiguring of OTT connection 2150 may include message format, retransmission settings, preferred routing etc.; the reconfiguring need not affect base station 2120, and it may be unknown or imperceptible to base station 2120. Such procedures and functionalities may be known and practiced in the art. In certain embodiments, measurements may involve proprietary UE signalling facilitating host computer 2110's measurements of throughput, propagation times, latency and the like. The measurements may be implemented in that software 2111 and 2131 causes messages to be transmitted, in particular empty or ‘dummy’ messages, using OTT connection 2150 while it monitors propagation times, errors etc.

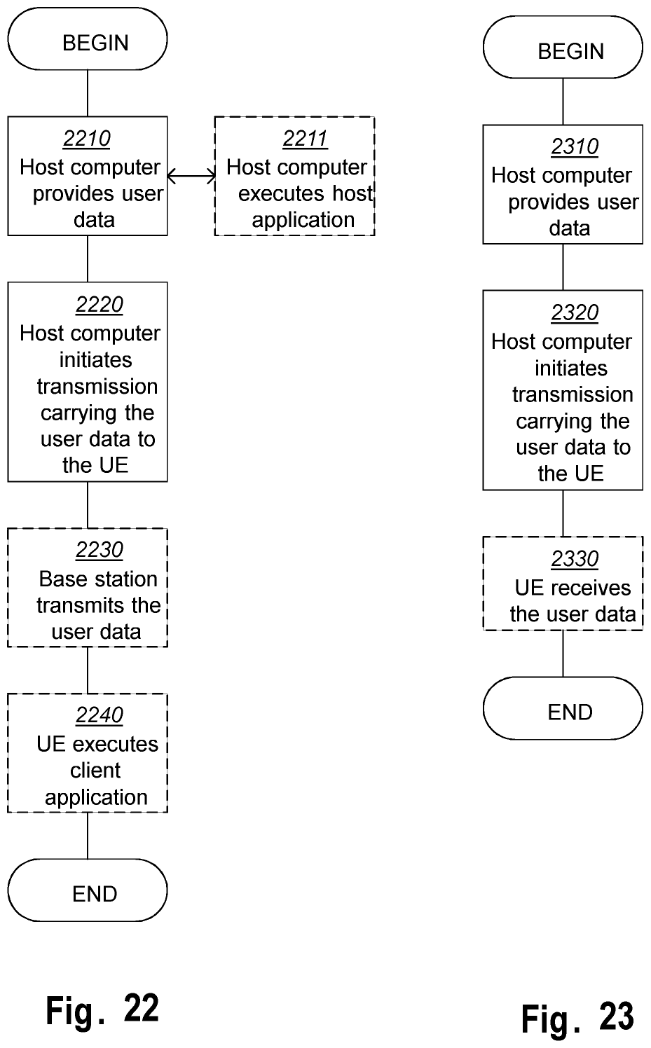

FIG. 22: Methods implemented in a communication system including a host computer, a base station and a user equipment in accordance with some embodiments.

FIG. 22 is a flowchart illustrating a method implemented in a communication system, in accordance with one embodiment. The communication system includes a host computer, a base station and a UE which may be those described with reference to FIGS. 20 and 21. For simplicity of the present disclosure, only drawing references to FIG. 22 will be included in this section. In step 2210, the host computer provides user data. In substep 2211 (which may be optional) of step 2210, the host computer provides the user data by executing a host application. In step 2220, the host computer initiates a transmission carrying the user data to the UE. In step 2230 (which may be optional), the base station transmits to the UE the user data which was carried in the transmission that the host computer initiated, in accordance with the teachings of the embodiments described throughout this disclosure. In step 2240 (which may also be optional), the UE executes a client application associated with the host application executed by the host computer.

FIG. 23: Methods implemented in a communication system including a host computer, a base station and a user equipment in accordance with some embodiments.

FIG. 23 is a flowchart illustrating a method implemented in a communication system, in accordance with one embodiment. The communication system includes a host computer, a base station and a UE which may be those described with reference to FIGS. 20 and 21. For simplicity of the present disclosure, only drawing references to FIG. 23 will be included in this section. In step 2310 of the method, the host computer provides user data. In an optional substep (not shown) the host computer provides the user data by executing a host application. In step 2320, the host computer initiates a transmission carrying the user data to the UE. The transmission may pass via the base station, in accordance with the teachings of the embodiments described throughout this disclosure. In step 2330 (which may be optional), the UE receives the user data carried in the transmission.

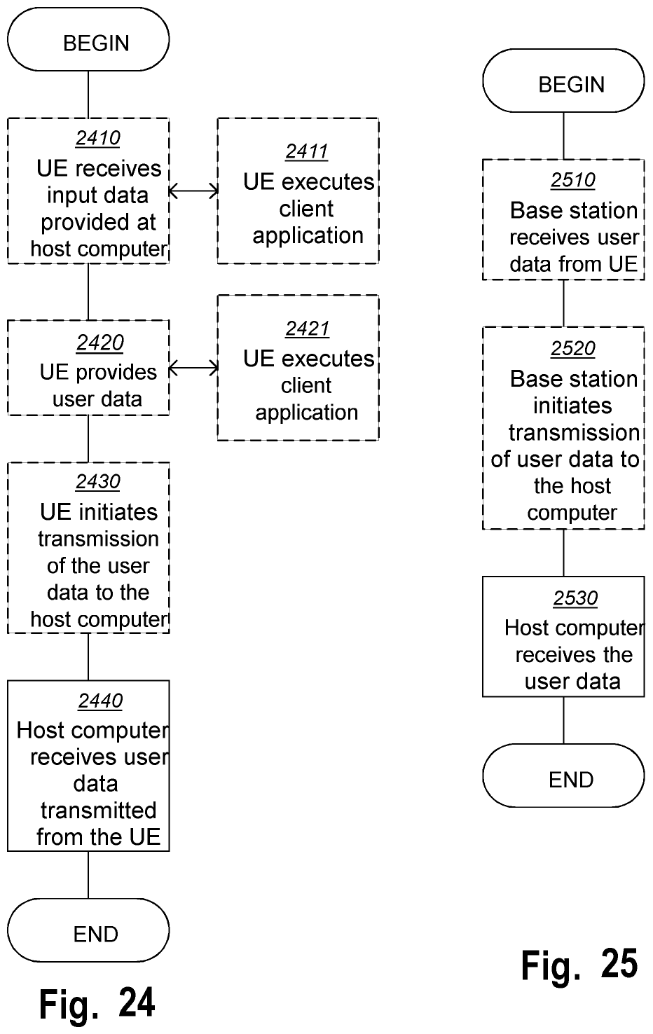

FIG. 24: Methods implemented in a communication system including a host computer, a base station and a user equipment in accordance with some embodiments

FIG. 24 is a flowchart illustrating a method implemented in a communication system, in accordance with one embodiment. The communication system includes a host computer, a base station and a UE which may be those described with reference to FIGS. 20 and 21. For simplicity of the present disclosure, only drawing references to FIG. 24 will be included in this section. In step 2410 (which may be optional), the UE receives input data provided by the host computer. Additionally or alternatively, in step 2420, the UE provides user data. In substep 2421 (which may be optional) of step 2420, the UE provides the user data by executing a client application. In substep 2411 (which may be optional) of step 2410, the UE executes a client application which provides the user data in reaction to the received input data provided by the host computer. In providing the user data, the executed client application may further consider user input received from the user. Regardless of the specific manner in which the user data was provided, the UE initiates, in substep 2430 (which may be optional), transmission of the user data to the host computer. In step 2440 of the method, the host computer receives the user data transmitted from the UE, in accordance with the teachings of the embodiments described throughout this disclosure.

FIG. 25: Methods implemented in a communication system including a host computer, a base station and a user equipment in accordance with some embodiments

FIG. 25 is a flowchart illustrating a method implemented in a communication system, in accordance with one embodiment. The communication system includes a host computer, a base station and a UE which may be those described with reference to FIGS. 20 and 21. For simplicity of the present disclosure, only drawing references to FIG. 25 will be included in this section. In step 2510 (which may be optional), in accordance with the teachings of the embodiments described throughout this disclosure, the base station receives user data from the UE. In step 2520 (which may be optional), the base station initiates transmission of the received user data to the host computer. In step 2530 (which may be optional), the host computer receives the user data carried in the transmission initiated by the base station.

Modifications and other embodiments of the disclosed embodiments will come to mind to one skilled in the art having the benefit of the teachings presented in the foregoing descriptions and the associated drawings. Therefore, it is to be understood that the embodiment(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1.-40. (canceled)

41. A method performed by a wireless device, the method being for handling positioning of the wireless device in a wireless communication network, the method comprising:
providing, to a radio network node comprised in the wireless communication network, at least one of:
i. information about a first location information request obtained from the radio network node in a Radio Resource Control (RRC) Reconfiguration message, and
ii. a location procedure configuration, the location procedure configuration being one of: a) a flag indication conveying to the radio network node that the wireless device has an ongoing positioning session, the flag indication being in an RRC message and b) a Packet Data Convergence Protocol (PDCP) Control protocol data unit (PDU) conveying to the radio network node that the wireless device has an ongoing positioning session.

42. The method according to claim 41, wherein the wireless device provides the information about the first location information request, and wherein the method further comprises:
providing, to the radio network node, a capability indication indicating a capability of the wireless device of positioning measurements in a Radio Resource Control (RRC) procedure.

43. The method of according to claim 42, wherein the capability indication is comprised in a MeasAndMobParameters information element.

44. The method according to claim 41, wherein the wireless device provides the information about the first location information request, and wherein the method further comprises obtaining the first location information request in the RRC Reconfiguration message.

45. The method according to claim 41, wherein the first location information request is comprised in a MeasConfig information element.

46. The method according to claim 41, wherein the information about the first location information request is a measurement report.

47. A method performed by a radio network node, the method being for handling positioning of a wireless device in a wireless communication network, the method comprising:
obtaining, from a wireless device comprised in the wireless communication network, at least one of:
i. information about a first location information request sent by the radio network node to the wireless device in a Radio Resource Control (RRC) Reconfiguration message, and
ii. a location procedure configuration, the location procedure configuration being one of: a) a flag indication conveying to the radio network node, that the wireless device has an ongoing positioning session, the flag indication being in an RRC message and b) a Packet Data Convergence Protocol (PDCP) Control protocol data unit (PDU) conveying to the radio network node that the wireless device has an ongoing positioning session.

48. The method according to claim 47, wherein the radio network node obtains the information about the first location information request, and wherein the method further comprises:
obtaining, from the wireless device, a capability indication indicating a capability of the wireless device of positioning measurements in a Radio Resource Control (RRC) procedure.

49. The method of according to claim 48, wherein the capability indication is comprised in a MeasAndMobParameters information element.

50. The method according to claim 47, further comprising:
initiating the first location information request in the RRC Reconfiguration message.

51. A wireless device, for handling positioning of the wireless device in a wireless communication network, the wireless device comprising:
a communication interface; and
processing circuitry configured to provide, to a radio network node comprised in the wireless communication network, at least one of:
i. information about a first location information request obtained from the radio network node in a Radio Resource Control (RRC) Reconfiguration message, and
ii. a location procedure configuration, the location procedure configuration being at least one of: a) a flag indication conveying to the radio network node that the wireless device has an ongoing positioning session, the flag indication being in an RRC message and b) a Packet Data Convergence Protocol (PDCP) Control protocol data unit (PDU) conveying to the radio network node that the wireless device has an ongoing positioning session.

52. The wireless device according to claim 51, wherein the processing circuitry is configured to provide the information about the first location information request, and wherein the processing circuitry is further configured to:
provide, to the radio network node, a capability indication indicating a capability of the wireless device of positioning measurements in a Radio Resource Control (RRC) procedure.

53. The wireless device of according to claim 52, wherein the capability indication is comprised in a MeasAndMobParameters information element.

54. The wireless device according to claim 51, wherein the processing circuitry is configured to provide the information about the first location information request, and wherein the processing circuitry is further configured to:
obtain the first location information request in the RRC Reconfiguration message.

55. A radio network node, for handling positioning of a wireless device in a wireless communication network, the radio network node comprising:
a communication interface; and
processing circuitry configured to obtain, from a wireless device comprised in the wireless communication network, at least one of:
i. information about a first location information request sent by the radio network node to the wireless device in a Radio Resource Control (RRC) Reconfiguration message, and
ii. a location procedure configuration, the location procedure configuration being one of: a) a flag indication conveying to the radio network node that the wireless device has an ongoing positioning session, the flag indication being in an RRC message and b) a Packet Data Convergence Protocol (PDCP) Control protocol data unit (PDU) conveying to the radio network node that the wireless device has an ongoing positioning session.

56. The radio network node according to claim 55, wherein the processing circuitry is configured to obtain the information about the first location information request, and wherein the processing circuitry is further configured to:
obtain, from the wireless device, a capability indication indicating a capability of the wireless device of positioning measurements in a Radio Resource Control (RRC) procedure.

57. The radio network node of according to claim 56, wherein the capability indication is comprised in a MeasAndMobParameters information element.
